(19) United States
(12) Patent Application Publication
(10) Pub. No.: US 2025/0198666 A1
(43) Pub. Date: Jun. 19, 2025

(54) CYCLIC OPERATION OF NON-CYCLIC HEAT EXCHANGER

(71) Applicant: Saudi Arabian Oil Company, Dhahran (SA)

(72) Inventors: Sultan A. Alankari, Al Khobar (SA); Ahmed M. Seoud, Dhahran (SA); Hussain A. Ali, Al Hofuf (SA); Alhassan A. Balharith, Najran (SA)

(21) Appl. No.: 18/543,742

(22) Filed: Dec. 18, 2023

(51) Int. Cl. F25B 15/02; F25B 30/04

(52) U.S. Cl. CPC F25B 15/02; F25B 30/04

(57) ABSTRACT

A method includes i) operating a non-cyclic heat exchanger in a heating mode by flowing a gas stream heated by the non-cyclic heat exchanger through a dehydrator bed to heat the dehydrator bed. The method includes ii) after the dehydrator bed reaches a target regeneration temperature, operating the non-cyclic heat exchanger in a cooling mode by diverting a first portion of the gas stream away from entering the first side of the non-cyclic heat exchanger and flowing the first portion of the gas stream through the dehydrator bed to cool the dehydrator bed. The method includes iii) after the dehydrator bed reaches a target dehydration temperature, operating the non-cyclic heat exchanger in a standby mode by flowing the gas stream from the non-cyclic heat exchanger around the dehydrator bed to bypass the dehydrator bed. The method includes repeating steps i), ii), and iii) to cyclically operate the non-cyclic heat exchanger.

### TECHNICAL FIELD

This disclosure relates to operation of heat exchangers.

### BACKGROUND

Heat exchangers are devices that transfer heat from one medium to another. For example, a heat exchanger can be used to cool a first medium by transferring heat from the first medium to a cooler, second medium. As another example, a heat exchanger can be used to heat a third medium by transferring heat from a hotter, fourth medium to the third medium. Heat can be transferred by conduction through the heat exchanger materials which separate the mediums being used. A common type of heat exchanger used is the shell-and-tube heat exchanger. Repeated thermal cycling can lead to fatigue and thermal stress in heat exchangers. During thermal cycling in heat exchange processes, components of the heat exchanger (such as pipes, joints, and gaskets) undergo constant cycles of heating and cooling, which can result in expansion and contraction and ultimately deformation of such components. This can lead to leaks, unplanned downtime, and reduced business performance.

### SUMMARY

This disclosure describes technologies relating to heat exchanger operation. Certain aspects of the subject matter described can be implemented as a method for cyclically operating a non-cyclic heat exchanger. The method includes i) operating the non-cyclic heat exchanger in a heating mode. Operating the non-cyclic heat exchanger in the heating mode includes flowing a gas stream heated by the non-cyclic heat exchanger through a dehydrator bed to heat the dehydrator bed to a target regeneration temperature at which the dehydrator bed regenerates. The method includes ii) after the dehydrator bed reaches the target regeneration temperature, operating the non-cyclic heat exchanger in a cooling mode. Operating the non-cyclic heat exchanger in the cooling mode includes diverting a first portion of the gas stream away from entering the first side of the non-cyclic heat exchanger and flowing the first portion of the gas stream through the dehydrator bed to cool the dehydrator bed to a target dehydrator temperature that is less than the target regeneration temperature. The method includes iii) after the dehydrator bed reaches the target dehydration temperature, operating the non-cyclic heat exchanger in a standby mode. Operating the non-cyclic heat exchanger in the standby mode includes flowing the gas stream from the non-cyclic heat exchanger around the dehydrator bed to bypass the dehydrator bed. The method includes iv) repeating steps i), ii), and iii) sequentially to cyclically operate the non-cyclic heat exchanger.

This, and other aspects, can include one or more of the following features. In some implementations, the heating mode is a first heating mode. In some implementations, the method includes operating the non-cyclic heat exchanger in a second heating mode Operating the non-cyclic heat exchanger in the second heating mode can include, after heating the gas stream, flowing at least a portion of the gas stream from the first side of the non-cyclic heat exchanger through a second dehydrator bed until the second dehydrator bed reaches a second target regeneration temperature and the second dehydrator bed has been regenerated. In some implementations, the cooling mode is a first cooling mode. In some implementations, the method includes, after the second dehydrator bed reaches the second target regeneration temperature, operating the non-cyclic heat exchanger in a second cooling mode. Operating the non-cyclic heat exchanger in the second cooling mode can include diverting a third portion of the gas stream away from entering the first side of the non-cyclic heat exchanger and flowing the third portion of the gas stream through the second dehydrator bed to cool the second dehydrator bed to a second target dehydration temperature. In some implementations, the non-cyclic heat exchanger is operated in the first heating mode and the second heating mode simultaneously. In some implementations, the non-cyclic heat exchanger is operated in the first cooling mode and the second cooling mode simultaneously. In some implementations, the non-cyclic heat exchanger is operated in the first heating mode and the second cooling mode simultaneously. In some implementations, the non-cyclic heat exchanger is operated in the second heating mode and the first cooling mode simultaneously. In some implementations, the non-cyclic heat exchanger is operated in the standby mode after the dehydrator bed reaches the target dehydration temperature and after the second dehydrator bed reaches the second target dehydration temperature.

Certain aspects of the subject matter described can be implemented as a system. The system includes a non-cyclic heat exchanger, an inlet flowline, an outlet flowline, a dehydrator bed, a discharge flowline, a cooling flowline, a bypass flowline, a heating control valve, a cooling control valve, a bypass control valve, and a controller. The non-cyclic heat exchanger includes a first side and a second side. The first side is configured to receive a process fluid. The second side is configured to receive a heating fluid. The non-cyclic heat exchanger is configured to transfer heat from the heating fluid flowing through the second side to the process fluid flowing through the first side. The inlet flowline is connected to an inlet of the first side of the non-cyclic heat exchanger. The outlet flowline is connected to an outlet of the first side of the non-cyclic heat exchanger. The dehydrator bed is connected to the outlet flowline. The discharge flowline is connected to the dehydrator bed. The outlet flowline and the discharge flowline are connected at opposite ends of the dehydrator bed. The cooling flowline branches from the inlet flowline and is connected to the dehydrator bed. The outlet flowline and the cooling flowline are connected at the same end of the dehydrator bed. The bypass flowline branches from the outlet flowline and is connected to the discharge flowline. The bypass flowline is configured to provide an alternative flow path for at least a portion of the process fluid flowing through the outlet flowline to bypass and avoid the dehydrator bed and flow directly to the discharge flowline. The heating control valve is disposed on the outlet flowline. The heating control valve is configured to adjust a flow rate of at least a portion of the process fluid through the outlet flowline to the dehydrator bed. The cooling control valve is disposed on the cooling flowline. The cooling control valve is configured to adjust a flow rate of at least a portion of the process fluid through the cooling flowline to the dehydrator bed. The bypass control valve is disposed on the bypass flowline. The bypass flowline is configured to adjust a flow rate of at least a portion of the process fluid through the bypass flowline avoiding the dehydrator bed to the discharge flowline. The controller is communicatively coupled to the heating control valve, the cooling control valve, and the bypass control valve. The controller is configured to cause the bypass control valve to at least partially open to flow at least a portion of the process fluid from the non-cyclic heat exchanger around the dehydrator bed to the discharge flowline, thereby bypassing the dehydrator bed while the non-cyclic heat exchanger operates.

This, and other aspects, can include one or more of the following features. In some implementations, the controller is configured to, after a standby mode of the non-cyclic heat exchanger and in a heating mode of the non-cyclic heat exchanger, cause the heating control valve to open, the cooling control valve to close, and the bypass control valve to close, thereby flowing at least a portion of the process fluid from the non-cyclic heat exchanger through the dehydrator bed to heat to a target regeneration temperature. In some implementations, the controller is configured to, after the heating mode and in a cooling mode of the non-cyclic heat exchanger, cause the heating control valve to close, the cooling control valve to open, and the bypass control valve to remain closed, thereby diverting a first portion of the process fluid around the non-cyclic heat exchanger to the dehydrator bed to cool to a target dehydration temperature. In some implementations, the controller is configured to, after the cooling mode and in the standby mode, cause the heating control valve to remain closed, the cooling control valve to close, and the bypass control valve to open, thereby flowing the process fluid from the non-cyclic heat exchanger around the dehydrator bed to the discharge flowline. In some implementations, the system includes a second outlet flowline branching from the outlet flowline and connected to a second dehydrator bed. In some implementations, the system includes a second heating control valve disposed on the second outlet flowline. The second heating control valve can be configured to adjust a flow rate of at least a portion of the process fluid through the second outlet flowline to the second dehydrator bed. In some implementations, the system includes a second cooling flowline branching from the inlet flowline and connected to the second dehydrator bed. In some implementations, the system includes a second cooling control valve disposed on the second cooling flowline. The second cooling control valve can be configured to adjust a flow rate of at least a portion of the process fluid through the second cooling flowline to the second dehydrator bed. In some implementations, the controller is communicatively coupled to the second heating control valve and the second cooling control valve. The heating mode can be a first cooling mode. The controller can be configured to, after the standby mode and in a second heating mode, cause the second heating control valve to open, the second cooling control valve to close, and the bypass control valve to close, thereby flowing at least a portion of the process fluid from the non-cyclic heat exchanger through the second dehydrator bed to heat to a second target regeneration temperature. In some implementations, the cooling mode is a first cooling mode. The controller can be configured to, after the second heating mode and in a second cooling mode, cause the second heating control valve to close, the second cooling control valve to open, and the bypass control valve to close, thereby diverting a second portion of the process fluid around the non-cyclic heat exchanger to the second dehydrator bed to cool to a second target dehydration temperature. In some implementations, the controller is configured to, in the first heating mode concurrently with the second heating mode, cause the first heating control valve and the second heating control valve to open, the first cooling control valve and the second cooling control valve to close, and the bypass control valve to close, thereby flowing a first heating portion of the process fluid from the non-cyclic heat exchanger through the dehydrator bed to heat to the target regeneration temperature and flowing a second heating portion of the process fluid from the non-cyclic heat exchanger through the second dehydrator bed to heat to the second target regeneration temperature. In some implementations, the controller is configured to, in the first cooling mode concurrently with the second cooling mode, cause the first heating control valve and the second heating control valve to close, the first cooling control valve and the second cooling control valve to open, and the bypass control valve to open, thereby diverting the first portion of the process fluid around the non-cyclic heat exchanger to the dehydrator bed to cool to the target dehydration temperature, diverting the second portion of the process fluid around the non-cyclic heat exchanger to the second dehydrator bed to cool to the second target dehydration temperature, and flowing a third portion of the process fluid from the non-cyclic heat exchanger around the dehydrator bed to bypass the dehydrator bed. In some implementations, the controller is configured to, in the first heating mode concurrently with the second cooling mode, cause the first heating control valve to open, the second heating control valve to close, the first cooling control valve to close, the second cooling control valve to open, and the bypass control valve to close, thereby flowing a heating portion of the process fluid from the non-cyclic heat exchanger through the dehydrator bed to heat to the target regeneration temperature and diverting a cooling portion of the process fluid around the non-cyclic heat exchanger to the second dehydrator bed to cool to a second target dehydration temperature. In some implementations, the controller is configured to, in the second heating mode concurrently with the first cooling mode, cause the first heating control valve to close, the second heating control valve to open, the first cooling control valve to open, the second cooling control valve to close, and the bypass control valve to close, thereby flowing a heating portion of the process fluid from the non-cyclic heat exchanger through the second dehydrator bed to heat to the second target regeneration temperature and diverting a cooling portion of the process fluid around the non-cyclic heat exchanger to the dehydrator bed to cool to the target dehydration temperature.

Certain aspects of the subject matter described can be implemented as a computer system. The computer system includes one or more processors. The computer system includes a non-transitory computer-readable storage medium coupled to the one or more processors and storing programming instructions for execution by the one or more processors. The programming instructions instructing the one or more processors to perform operations. The operations include operating the non-cyclic heat exchanger in a first heating mode. Operating the non-cyclic heat exchanger in the first heating mode includes causing a first heating control valve disposed on a first outlet flowline connecting the non-cyclic heat exchanger to a first dehydrator bed to open. Operating the non-cyclic heat exchanger in the first heating mode includes causing a first cooling control valve disposed on a first cooling flowline branching from an inlet flowline upstream of the non-cyclic heat exchanger and connecting to the first dehydrator bed to close. Operating the non-cyclic heat exchanger in the first heating mode includes causing a bypass control valve disposed on a bypass flowline branching from the first outlet flowline and connecting to a discharge flowline downstream of the first dehydrator bed to close. Causing the first heating control valve to open, the first cooling control valve to close, and the bypass control valve to close allows at least a portion of a process fluid to flow from the non-cyclic heat exchanger through the first dehydrator bed to heat to a first target regeneration temperature. The operations include, after operating the non-cyclic heat exchanger in the first heating mode, operating the non-cyclic heat exchanger in a first cooling mode. Operating the non-cyclic heat exchanger in the first cooling mode includes causing the first heating control valve to close, the first cooling control valve to open, and the bypass control valve to remain closed, thereby diverting at least a portion of the process fluid around the non-cyclic heat exchanger to the first dehydrator bed to cool to a first target dehydration temperature. The operations include, after operating the non-cyclic heat exchanger in the first cooling mode, operating the non-cyclic heat exchanger in a standby mode. Operating the non-cyclic heat exchanger in the standby mode includes causing the first heating control valve to remain closed the first cooling control valve to close, and the bypass control valve to open, thereby flowing at least a portion of the process fluid from the non-cyclic heat exchanger around the dehydrator bed to the discharge flowline. The operations include, after operating the non-cyclic heat exchanger in the standby mode, re-operating the non-cyclic heat exchanger in the first heating mode to regenerate the first dehydrator bed.

This, and other aspects, can include one or more of the following features. In some implementations, the operations include operating the non-cyclic heat exchanger in a second heating mode. Operating the non-cyclic heat exchanger in the second heating mode can include causing a second heating control valve disposed on a second outlet flowline branching from the first outlet flowline and connecting to a second dehydrator bed to open. Operating the non-cyclic heat exchanger in the second heating mode can include causing a second cooling control valve disposed on a second cooling flowline branching from the inlet flowline and connecting to the second dehydrator bed to close. Operating the non-cyclic heat exchanger in the second heating mode can include causing the bypass control valve to close. Causing the second heating control valve to open, the second cooling control valve to close, and the bypass control valve to close allows at least a portion of a process fluid to flow from the non-cyclic heat exchanger through the second dehydrator bed to heat to a second target regeneration temperature. In some implementations, the operations include operating the non-cyclic heat exchanger in a second cooling mode. Operating the non-cyclic heat exchanger in the second cooling mode can include causing the second heating control valve to close, the second cooling control valve to open, and the bypass control valve to remain closed, thereby diverting a second portion of the process fluid around the non-cyclic heat exchanger to the second dehydrator bed to cool to a second target dehydration temperature.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example system including a non-cyclic heat exchanger in cyclic operation.

FIG. 1B is the system of FIG. 1A in a first mode.

FIG. 1C is the system of FIG. 1A in a second mode.

FIG. 1D is the system of FIG. 1A in a third mode.

FIG. 2A is a schematic diagram of an example system including a non-cyclic heat exchanger in cyclic operation.

FIG. 2B is the system of FIG. 2A in a first mode.

FIG. 2C is the system of FIG. 2A in a second mode.

FIG. 2D is the system of FIG. 2A in a third mode.

FIG. 2E is the system of FIG. 2A in a fourth mode.

FIG. 2F is the system of FIG. 2A in a fifth mode.

FIG. 3 is a flow chart of an example method for cyclically operating a non-cyclic heat exchanger.

FIG. 4 is a schematic diagram of an example computer that can be used to implement the method whose flow chart is shown in FIG. 3. The example computer of FIG. 4 can be implemented to automate processes (for example, open and close control valves) in the example systems of FIGS. 1A-1D and FIGS. 2A-2F.

### DETAILED DESCRIPTION

This disclosure describes cyclic operation of a non-cyclic heat exchanger. The non-cyclic heat exchanger is used to heat a process fluid, such as a gas stream. The gas stream can be, for example, a gas stream that has been dehydrated after flowing through a dehydrator bed. As the dehydrator bed operates to dehydrate a process fluid, water may accumulate on the dehydrator bed. At a certain point, the dehydrator bed requires regeneration, so that the dehydrator bed may continue to operate as a dehydrator. Regeneration of the dehydrator bed can include heating the dehydrator bed, such that the water that has accumulated on the dehydrator bed to evaporate and/or desorb from the dehydrator bed, such that the dehydrator bed is regenerated. Heating the dehydrator bed can involve flowing the gas stream that has been heated by the non-cyclic heat exchanger through the dehydrator bed. Once the dehydrator bed has been regenerated, the dehydrator bed is cooled back down to its original operating conditions at which the dehydrator bed performs the dehydration of the process fluid. Cooling the dehydrator bed can include flowing at least a portion of the gas stream prior to the gas stream entering the non-cyclic heat exchanger. While cooling the dehydrator bed, a remaining portion of the gas stream can be heated by the non-cyclic heat exchanger and bypass (avoid) the dehydrator bed. Once the dehydrator bed has been cooled, the non-cyclic heat exchanger can be operated in a standby mode in which the gas stream that has been heated by the non-cyclic heat exchanger bypasses (avoids) the dehydrator bed as the dehydrator bed performs its dehydrating duty. In this manner, the non-cyclic heat exchanger can be operated cyclically, such that the non-cyclic heat exchanger avoids drastic fluctuations in operating conditions, thereby mitigating and/or eliminating potential of equipment failure.

The subject matter described in this disclosure can be implemented in particular implementations, so as to realize one or more of the following advantages. The systems and methods described implement a bypass line for an outlet of a non-cyclic heat exchanger, so that the non-cyclic heat exchanger can be operated continuously and cyclically without drastic fluctuations in operating conditions. By allowing the process fluid heated by the non-cyclic heat exchanger to bypass one or more equipment, the heat exchanger can continuously operate without requiring down periods which bring the heat exchanger to low temperatures and back up to high temperatures when the heat exchanger is needed to operate again. By including the bypass flowline, the heat exchanger is continuously operated without drastic fluctuations in operating range. Drastic fluctuations in operating conditions can detrimentally affect process equipment (such as non-cyclic heat exchangers). For example, drastic fluctuations (such as fluctuations in operating temperature having a range of about 200 degrees Fahrenheit (° F.) differential or more or about 250° F. differential or more) can impart thermal stress on gaskets of the heat exchanger, which can result in deformation of the components of the heat exchanger and can, in turn, result in leakage of fluid from the heat exchanger. By including the bypass flowline, the heat exchanger can be continuously operated within a narrower operating range (for example, within a range of about 100° F. differential or within a range of about 50° F. differential), such that the thermal stress due to fluctuations in operating conditions are mitigated and/or eliminated. The systems and methods described allow for flexible operation and can be used to heat a dehydrator bed to regenerate the dehydrator bed and also cool another dehydrator bed at the same time without requiring isolation of the heat exchanger.

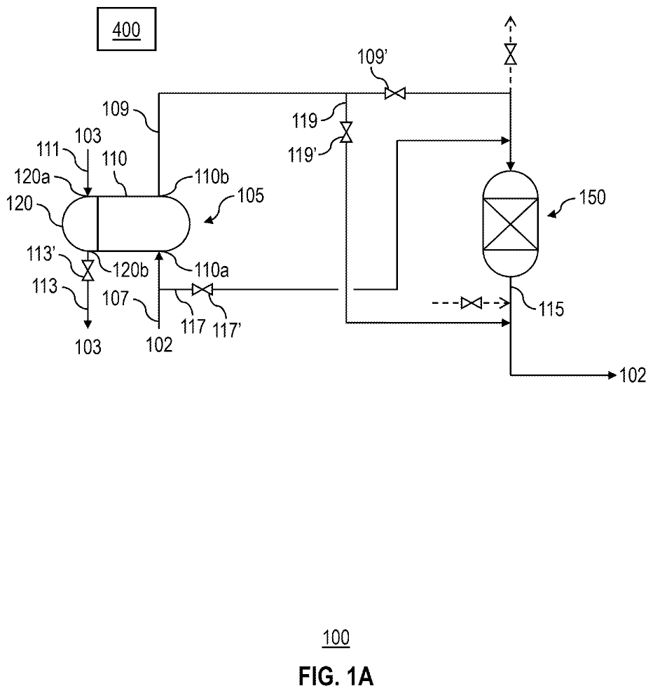

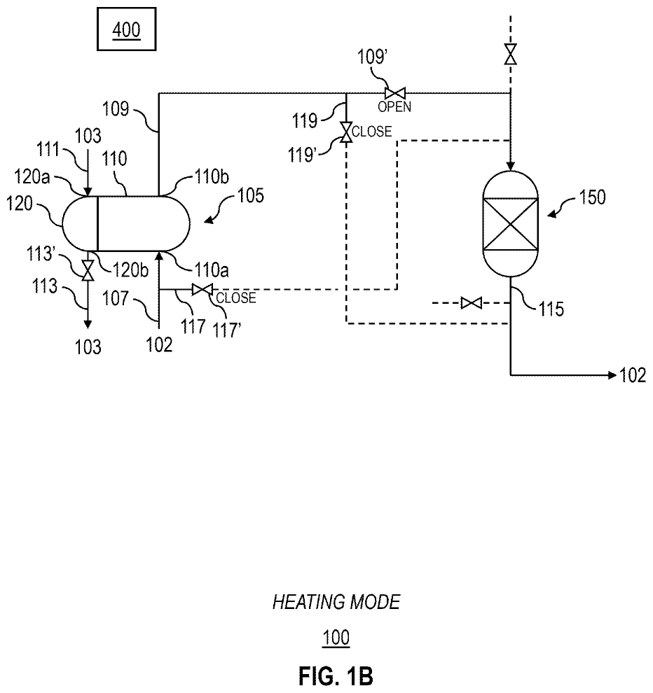

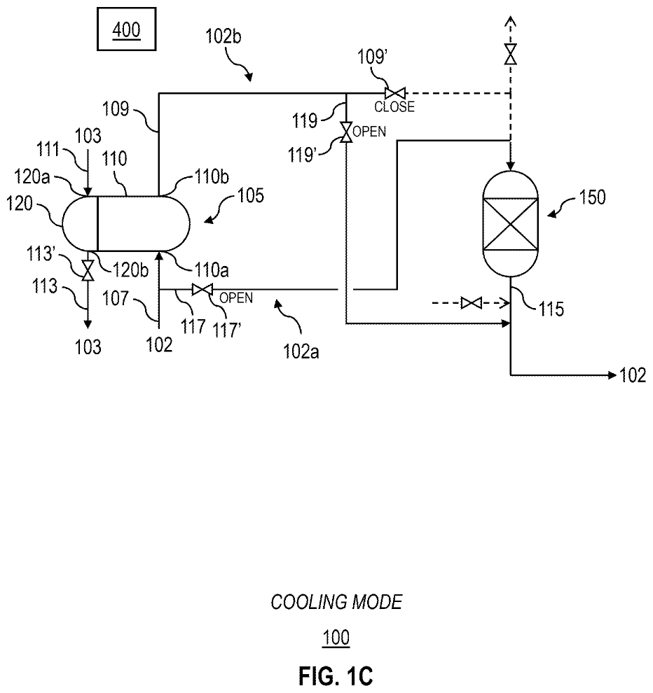

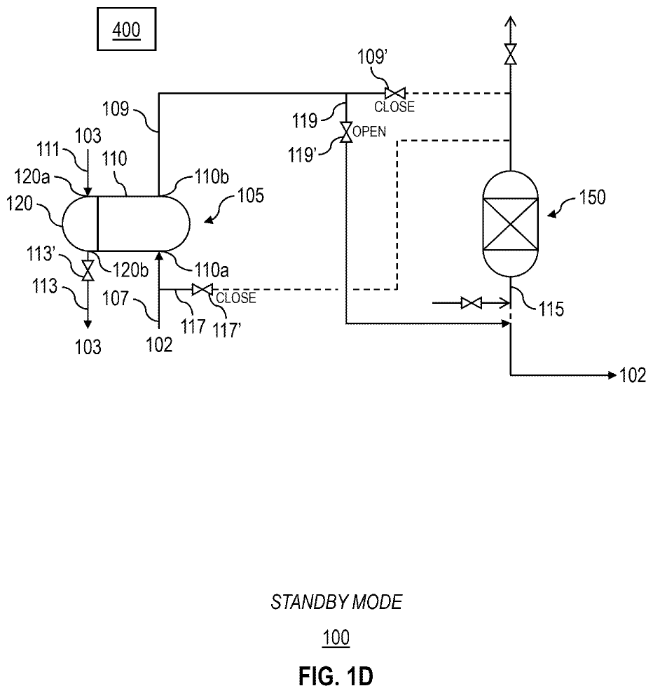

FIG. 1A depicts an example system 100 in which a non-cyclic heat exchanger 105 is operated cyclically. The heat exchanger 105 has a first side 110 and a second side 120. In some implementations, the heat exchanger 105 is a shell-and-tube-type heat exchanger. The first side 110 can, for example, be the shell side of the heat exchanger 105. The second side 120 can, for example, be the tube side (at least partially disposed within the shell side) of the heat exchanger 105. The first side 110 can be configured to receive a process fluid 102 (for example, a gas or liquid) via an inlet 110a. The inlet 110a of the first side 110 is connected to an inlet flowline 107. The process fluid 102 flows through the inlet flowline 107 to the inlet 110a of the first side 110. The outlet 110b of the first side 110 is connected to an outlet flowline 109. The process fluid 102 flows through the first side 110 of the heat exchanger 105. The process fluid 102 flows out of the first side 110 via the outlet 110b of the first side 110 to the outlet flowline 109. The second side 120 can be configured to receive a heating fluid 103 (such as hot oil) via an inlet 120a. The inlet 120a of the second side 120 is connected to a heating inlet flowline 111. The heating fluid 103 flows through the heating inlet flowline 111 to the inlet 120a of the second side 120. The outlet 120b of the second side 120 is connected to a heating outlet flowline 113. The heating fluid 103 flows through the second side 120 of the heat exchanger 105. The heating fluid 103 flows out of the second side 120 via the outlet 120b of the second side 120 to the heating outlet flowline 113. The heat exchanger 105 is configured to transfer heat from the heating fluid 103 flowing through the second side 120 to the process fluid 102 flowing through the first side 110. The process fluid 102 and the heating fluid 103 do not come into direct contact with one another in the heat exchanger 105. Instead, the heat exchanger 105 provides an intermediary heat transfer area to facilitate transfer of heat from the heating fluid 103 to the process fluid 102.

The system 100 includes a dehydrator bed 150. A fluid (such as the process fluid 102) can flow through the dehydrator bed 150. The dehydrator bed 150 can be configured to dehydrate the fluid (such as the process fluid 102) as the fluid flows through the dehydrator bed 150. For example, the dehydrator bed 150 can include a desiccant or other material that has a high affinity to water. In some implementations, the dehydrator bed 150 includes molecular sieve desiccants of varying sizes layered within the vessel of the dehydrator bed 150 for efficient moisture removal. For example, the dehydrator bed 150 includes molecular sieve desiccants having a pore size ranging from about 3 angstroms to about 5 angstroms or from about 3 angstroms to about 4 angstroms. As another example, the dehydrator bed 150 includes molecular sieve desiccants having sizes ranging from 3 A to 5 A, such as 3 A, 4 A, or 5 A. A 3 A molecular sieve desiccant has a pore size of about 3 angstroms, a 4 A molecular sieve desiccant has a pore size of about 4 angstroms, and a 5 A molecular sieve desiccant has a pore size of about 5 angstroms. As the fluid (such as the process fluid 102) flows through the dehydrator bed 150, the desiccant (or other material with high water affinity) removes water molecules from the fluid. As the dehydrator bed 150 operates, water may accumulate on the dehydrator bed 150 to a point at which the water-absorbing/adsorbing ability of the dehydrator bed 150 is hindered. At such an operating point, it can be beneficial to regenerate the dehydrator bed 150 by removing the accumulated water, so that the water-absorbing/adsorbing ability of the dehydrator bed 150 is re-established. Regenerating the dehydrator bed 150 can include heating the dehydrator bed 150 to a target regeneration temperature at which the dehydrator bed 150 is regenerated. Heating the dehydrator bed 150 to the target regeneration temperature can cause the accumulated water on the dehydrator bed 150 to evaporate. The evaporated water (steam) can be flowed away from the dehydrator bed 150, so that the dehydrator bed 150 is regenerated and can be re-used to dehydrate a fluid (such as the process fluid 102).

The outlet flowline 109 is connected to the dehydrator bed 150. When the heat exchanger 105 is in a heating mode, the process fluid 102 flows from the first side 110 of the heat exchanger 105 to the dehydrator bed 150 via the outlet flowline 109. In the heating mode, the heat from the process fluid 102 (heated by the heat exchanger 105) can be transferred to the dehydrator bed 150 to regenerate the dehydrator bed 150. Heating the dehydrator bed 150 with the process fluid 102 can cause water to desorb and/or evaporate from the dehydrator bed 150. The desorbed/evaporated water can then flow away from the dehydrator bed 150 (for example, with the process fluid 102) to regenerate the dehydrator bed 150. The process fluid 102 flowing through the dehydrator bed 150 in the heating mode can heat the dehydrator bed 150 to the target regeneration temperature at which the dehydrator bed 150 is regenerated. In some implementations, the target regeneration temperature is in a range of from about 280 degrees Celsius (° C.) to about 295° C. or from about 282° C. to about 292° C. In the heating mode, the dehydrator bed 150 is in the process of regenerating and is not used to dehydrate a fluid. A discharge flowline 115 is connected to the dehydrator bed 150. The outlet flowline 109 and the discharge flowline 115 are connected to the dehydrator bed 150 at opposite ends of the dehydrator bed 150.

Once the dehydrator bed 150 has been regenerated, the heat exchanger 105 can be switched to a cooling mode. A cooling flowline 117 branches from the inlet flowline 107 and connects to the dehydrator bed 150. In some implementations, the cooling flowline 117 and the outlet flowline 109 are connected to the dehydrator bed 150 at the same end of the dehydrator bed 150. In the cooling mode, the process fluid 102 is diverted away from the heat exchanger 105, such that the process fluid 102 flows to the dehydrator bed 150 instead of flowing through the first side 110 of the heat exchanger 105. Because the process fluid 102 bypasses the heat exchanger 105 in the cooling mode, the process fluid 102 is not heated. The process fluid 102 flows through the dehydrator bed 150 and cools the dehydrator bed 150 to a target dehydration temperature that is less than the target regeneration temperature. In some implementations, the target dehydration temperature is in a range of from about 25° C. to about 35° C. or from about 28° C. to about 31° C. Once the dehydrator bed 150 reaches the target dehydration temperature, the dehydrator bed 150 is ready to be re-used to dehydrate a fluid. In some implementations, a portion of the process fluid 102 is diverted to the dehydrator bed 150 via the cooling flowline 117, while a remainder of the process fluid 102 flows through the first side 110 of the heat exchanger 105. The remainder of the process fluid 102 that flows through the heat exchanger 105 is heated by the heat exchanger 105 but is not flowed through the dehydrator bed 150. This remainder of the process fluid 102 can, for example, be flowed to a different process equipment or simply bypass the dehydrator bed 150.

Once the dehydrator bed 150 has reached the target dehydration temperature, the heat exchanger 105 can be switched to a standby mode. In the standby mode, the dehydrator bed 150 operates to dehydrate a fluid, such as the process fluid 102 prior to the process fluid 102 entering the heat exchanger 105. In the standby mode, the process fluid 102 exits the heat exchanger 105 and bypasses the dehydrator bed 150 via a bypass flowline 119 that branches from the outlet flowline 109 and connects to the discharge flowline 115. The bypass flowline 119 is configured to provide an alternative flow path for the process fluid 102 to bypass and avoid the dehydrator bed 150.

The system 100 includes a flow control system that includes a controller 400 that is communicatively coupled to various components of the system 100. A heating control valve 109′ is disposed on the outlet flowline 109. The heating control valve 109′ is configured to adjust a flow rate of at least a portion of the process fluid 102 through the outlet flowline 109 to the dehydrator bed 150. For example, a percent (%) opening of the heating control valve 109′ is adjustable, and adjusting the % opening of the heating control valve 109′ adjusts the flow rate of the portion of the process fluid 102 flowing through the outlet flowline 109. Decreasing the % opening of the heating control valve 109′ decreases the flow rate of the portion of the process fluid 102 flowing through the outlet flowline 109, and increasing the % opening of the heating control valve 109′ increases the flow rate of the portion of the process fluid 102 flowing through the outlet flowline 109. A cooling control valve 117′ is disposed on the cooling flowline 117. The cooling control valve 117′ is configured to adjust a flow rate of at least a portion of the process fluid 102 through the cooling flowline 117 to the dehydrator bed 150. For example, a % opening of the cooling control valve 117′ is adjustable, and adjusting the % opening of the cooling control valve 117′ adjusts the flow rate of the portion of the process fluid 102 flowing through the cooling flowline 117. Decreasing the % opening of the cooling control valve 117′ decreases the flow rate of the portion of the process fluid 102 flowing through the cooling flowline 117, and increasing the % opening of the cooling control valve 117′ increases the flow rate of the portion of the process fluid 102 flowing through the cooling flowline 117. A bypass control valve 119′ is disposed on the bypass flowline 119. The bypass control valve 119′ is configured to adjust a flow rate of at least a portion of the process fluid 102 through the bypass flowline 119 avoiding the dehydrator bed 150 to the discharge flowline 115. For example, a % opening of the bypass control valve 119′ is adjustable, and adjusting the % opening of the bypass control valve 119′ adjusts the flow rate of the portion of the process fluid 102 flowing through the bypass flowline 119. Decreasing the % opening of the bypass control valve 119′ decreases the flow rate of the portion of the process fluid 102 flowing through the bypass flowline 119, and increasing the % opening of the bypass control valve 119′ increases the flow rate of the portion of the process fluid 102 flowing through the bypass flowline 119. The heating control valve 109′, the cooling control valve 117′, and the bypass control valve 119′ are communicatively coupled to the controller 400. Although not shown in FIG. 1A, the controller 400 can also be communicatively coupled to additional components, such as additional control valves and/or sensors (such as temperature sensor(s), pressure sensor(s), and flow sensor(s)).

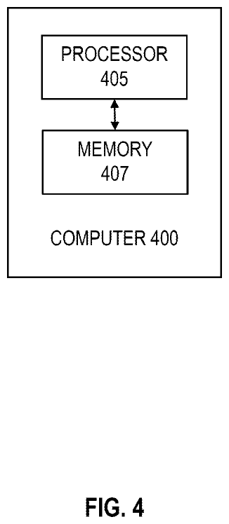

The controller 400 is configured to communicate with (for example, send signal(s) to and/or receive signal(s) from) the heating control valve 109′, the cooling control valve 117′, and the bypass control valve 119′ to control the respective % openings of the valves. The controller 400 can adjust the % openings of the heating control valve 109′, the cooling control valve 117′, and the bypass control valve 119′ to align with the operating mode (for example, heating, cooling, standby) of the heat exchanger 105. The controller 400 is also shown in FIG. 4 and is described in more detail later.

FIG. 1B depicts the system 100 when the heat exchanger 105 is in the heating mode. The heating mode can begin once the dehydrator bed 150 requires regeneration to remove the accumulated water. In the heating mode, the process fluid 102 flows through the first side 110 of the heat exchanger 105. While the process fluid 102 flows through the first side 110, the heating fluid 103 flows through the second side 120 of the heat exchanger. Heat is transferred via the heat exchanger 105 from the heating fluid 103 flowing through the second side 120 to the process fluid 102 flowing through the first side 110. The heated process fluid 102 flows from the first side 110 of the heat exchanger 105 through the dehydrator bed 150. Flowing the heated process fluid 102 through the dehydrator bed 150 heats the dehydrator bed 150. The process fluid 102 exiting the dehydrator bed 150 can be further processed, for example, to filter the process fluid 102, to cool the process fluid 102, to compress the process fluid 102, or any combinations of these. The heated process fluid 102 is continued to flow through the dehydrator bed 150 until the dehydrator bed 150 reaches the target regeneration temperature. In the heating mode, the controller 400 communicates with the heating control valve 109′ to ensure the heating control valve 109′ remains open. In the heating mode, the controller 400 communicates with the cooling control valve 117′ to ensure the cooling control valve 117′ remains closed. In the heating mode, the controller 400 communicates with the bypass control valve 119′ to ensure the bypass control valve 119′ remains closed. In the heating mode, with the heating control valve 109′ open, the cooling control valve 117′ closed, and the bypass control valve 119′ closed, all of the process fluid 102 heated by the heat exchanger 105 flows through the dehydrator bed 150 to heat the dehydrator bed 150. In some implementations, the system 100 includes a temperature sensor (not shown) coupled to the dehydrator bed 150. The temperature sensor can measure an operating temperature of the dehydrator bed 150. The temperature sensor can be communicatively coupled to the controller 400 and transmit a temperature signal to the controller 400 representing the measured operating temperature of the dehydrator bed 150. The controller 400 can be configured to compare the measured operating temperature of the dehydrator bed 150 received from the temperature sensor with the target regeneration temperature. Once the controller 400 has determined that the dehydrator bed 150 has reached the target regeneration temperature, the controller 400 can be configured to automatically switch the system 100 and the heat exchanger 105 to the cooling mode.

Once the dehydrator bed 150 has reached the target regeneration temperature, and the dehydrator bed 150 has been regenerated, the heat exchanger 105 can be switched in operation to the cooling mode. FIG. 1C depicts the system 100 when the heat exchanger 105 is in the cooling mode. In the cooling mode, a first portion 102a of the process fluid 102 is diverted away from entering the first side 110 of the heat exchanger 105 and is instead flowed through the dehydrator bed 150. Because the first portion 102a has not flowed through the first side 110 of the heat exchanger 105, the first portion 102a remains cool. Flowing the first portion 102a through the dehydrator bed 150 cools the dehydrator bed 150. In some implementations, a flow rate of the heating fluid 103 flowing through the second side 120 of the heat exchanger 105 is decreased in the cooling mode to decrease the rate of heat transfer from the heating fluid 103 to the second portion 102b of the process fluid 102 flowing through the first side 110 of the heat exchanger 105. For example, the system 100 can include a hot medium control valve 113′ disposed on the heating outlet flowline 113 flowing the heating fluid 103 from the second side 120 of the heat exchanger 105. As another example, the hot medium control valve 113′ is disposed on the heating inlet flowline 111 flowing the heating fluid 103 to the second side 120 of the heat exchanger 105. The controller 400 can be communicatively coupled to the hot medium control valve 113′. The controller 400 can adjust a % opening of the hot medium control valve 113′ to adjust a flow of the heating fluid 103 flowing through the second side 120 of the heat exchanger 105. Decreasing the % opening of the hot medium control valve 113′ decreases the flow rate of the heating medium 103 flowing through the second side 120 of the heat exchanger 105, and increasing the % opening of the hot medium control valve 113′ increases the flow rate of the heating medium 103 flowing through the second side 120 of the heat exchanger 105. Decreasing the flow rate of the heating fluid 103 can allow for the second portion 102b of the process fluid 102 exiting the first side 110 to remain at substantially the same temperature as the process fluid 102 exiting the first side 110 in the heating mode, so that the operating conditions of the heat exchanger 105 do not fluctuate drastically. The second portion 102b flows from the first side 110 and through the bypass flowline 119 around the dehydrator bed 150 to avoid the dehydrator bed 150 and rejoins the first portion 102a exiting the dehydrator bed 150. The rejoined process stream 102 (downstream of the dehydrator bed 150) can be further processed, for example, to filter the process fluid 102, to cool the process fluid 102, to compress the process fluid 102, or any combinations of these. The first portion 102a of the process fluid 102 is continued to flow through the dehydrator bed 150 until the dehydrator bed 150 reaches the target dehydration temperature. In the cooling mode, the controller 400 communicates with the heating control valve 109′ to ensure the heating control valve 109′ remains closed. In the cooling mode, the controller 400 communicates with the cooling control valve 117′ to ensure the cooling control valve 117′ remains open. In the cooling mode, the controller 400 communicates with the bypass control valve 119′ to ensure the bypass control valve 119′ remains at least partially open. In the cooling mode, with the heating control valve 109′ closed, the cooling control valve 117′ open, and the bypass control valve 119′ at least partially open, the first portion 102a of the process fluid 102 (that is not heated by the heat exchanger 105) flows through the dehydrator bed 150 to cool the dehydrator bed 150, while the remaining second portion 102b of the process fluid (heated by the heat exchanger 105) bypasses the dehydrator 150. The controller 400 can be configured to compare the measured operating temperature of the dehydrator bed 150 received from the temperature sensor with the target dehydration temperature. Once the controller 400 has determined that the dehydrator bed 150 has reached the target dehydration temperature, the controller 400 can be configured to automatically switch the system 100 and the heat exchanger 105 to the standby mode.

Once the dehydrator bed 150 has reached the target dehydration temperature, and the dehydrator bed 150 is ready to be used again to dehydrate a fluid, the heat exchanger 105 can be switched in operation to the standby mode. FIG. 1D is the system 100 when the heat exchanger 105 is in the standby mode. In the standby mode, the process fluid 102 flows through the first side 110 of the heat exchanger 105. While the process fluid 102 flows through the first side 110, the heating fluid 103 flows through the second side 120 of the heat exchanger. Heat is transferred via the heat exchanger 105 from the heating fluid 103 flowing through the second side 120 to the process fluid 102 flowing through the first side 110. The process fluid 102 flows from the first side 110 and through the bypass flowline 119 around the dehydrator bed 150 to avoid the dehydrator bed 150. The process stream 102 (downstream of the dehydrator bed 150) can be further processed, for example, to filter the process fluid 102, to cool the process fluid 102, to compress the process fluid 102, or any combinations of these. In the standby mode, the dehydrator bed 150 operates to dehydrate a fluid (for example, the process fluid 102 prior to entering the heat exchanger 105). In the standby mode, the controller 400 communicates with the heating control valve 109′ to ensure the heating control valve 109′ remains closed. In the standby mode, the controller 400 communicates with the cooling control valve 117′ to ensure the cooling control valve 117′ remains closed. In the standby mode, the controller 400 communicates with the bypass control valve 119′ to ensure the bypass control valve 119′ remains at least partially open. In the standby mode, with the heating control valve 109′ closed, the cooling control valve 117′ closed, and the bypass control valve 119′ at least partially open, the process fluid 102 bypasses the dehydrator 150. Because the bypass control valve 119′ is partially open, the flow rate of the process fluid 102 may be decreased in comparison to the flow rate of the process fluid 102 while the heat exchanger 105 is in the heating mode. In some implementations, a flow rate of the heating fluid 103 flowing through the second side 120 of the heat exchanger 105 is decreased in the standby mode (for example, the same flow rate of the heating fluid 103 while the heat exchanger 105 is in the cooling mode) to decrease the rate of heat transfer from the heating fluid 103 to the process fluid 102 flowing through the first side 110 of the heat exchanger 105. Decreasing the flow rate of the heating fluid 103 can allow for the process fluid 102 exiting the first side 110 in the standby mode to remain at substantially the same temperature as the process fluid 102 exiting the first side 110 in the heating mode, so that the operating conditions of the heat exchanger 105 do not fluctuate drastically. Once the dehydrator bed 150 reaches a point at which the dehydrator bed 150 requires regeneration to remove the accumulated water, the heat exchanger 105 (and system 100) can be switched back to the heating mode (FIG. 1B). In this way, the non-cyclic heat exchanger 105 can be operated cyclically through the heating mode (FIG. 1B), the cooling mode (FIG. 1C), and the standby mode (FIG. 1D). Adjustment of flow rate of the heating fluid 103 through the second side 120 of the heat exchanger 105 allows for the heat exchanger 105 to be continually operated throughout each of the modes with its operating conditions remaining substantially stable, free of drastic fluctuations.

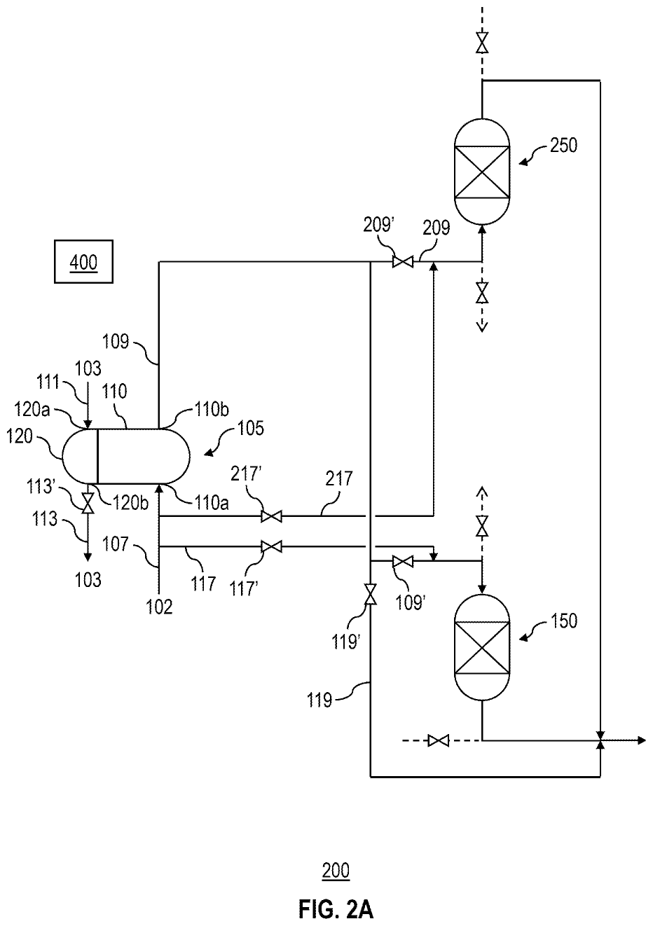

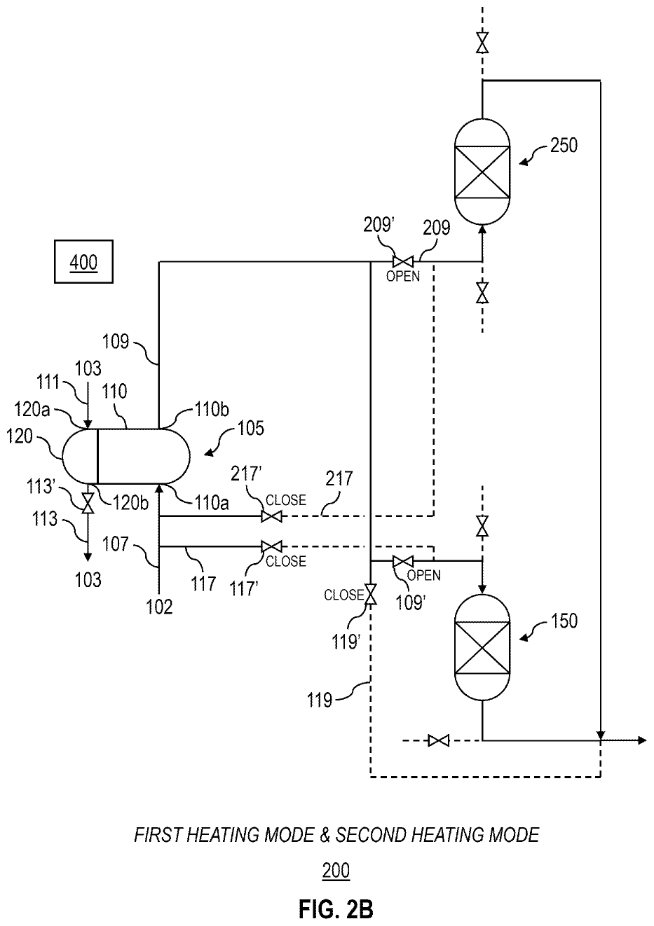

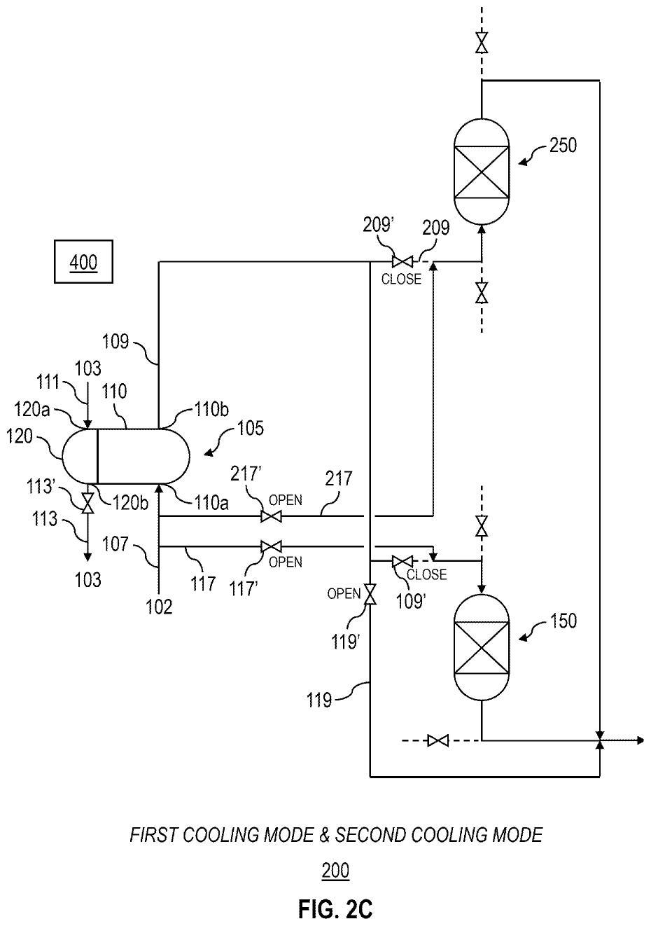

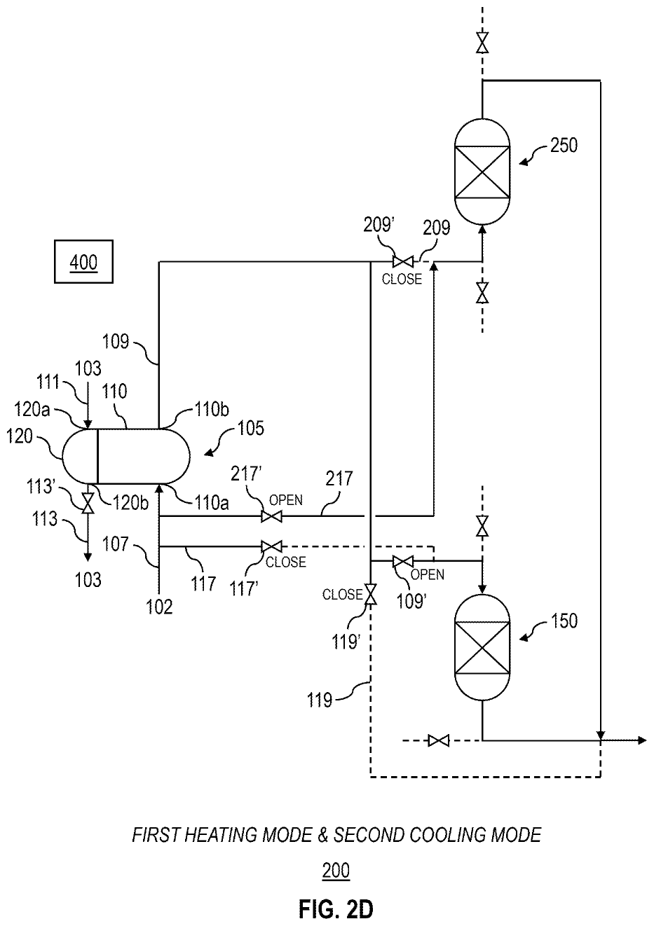

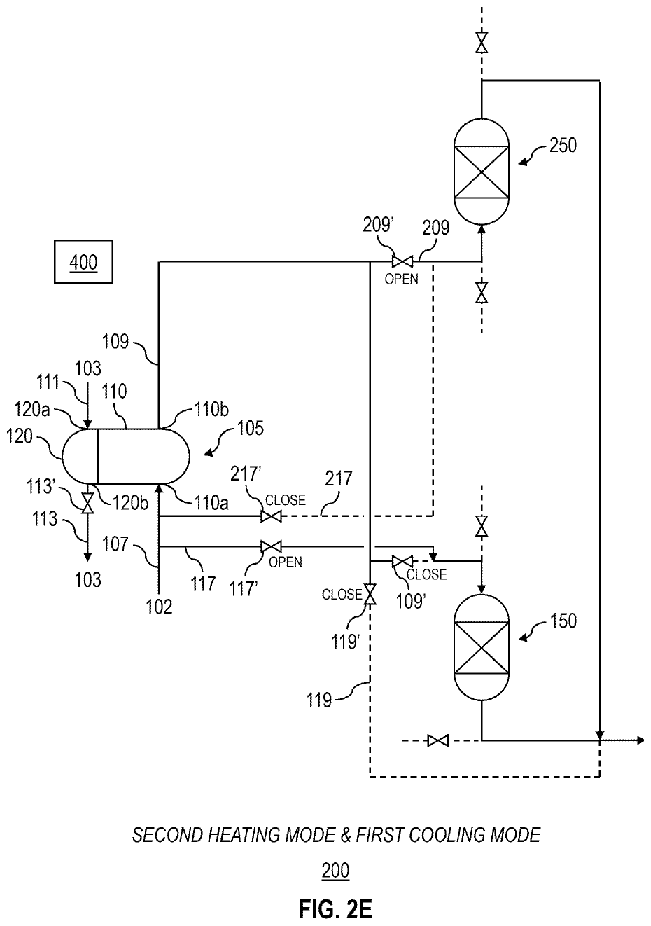

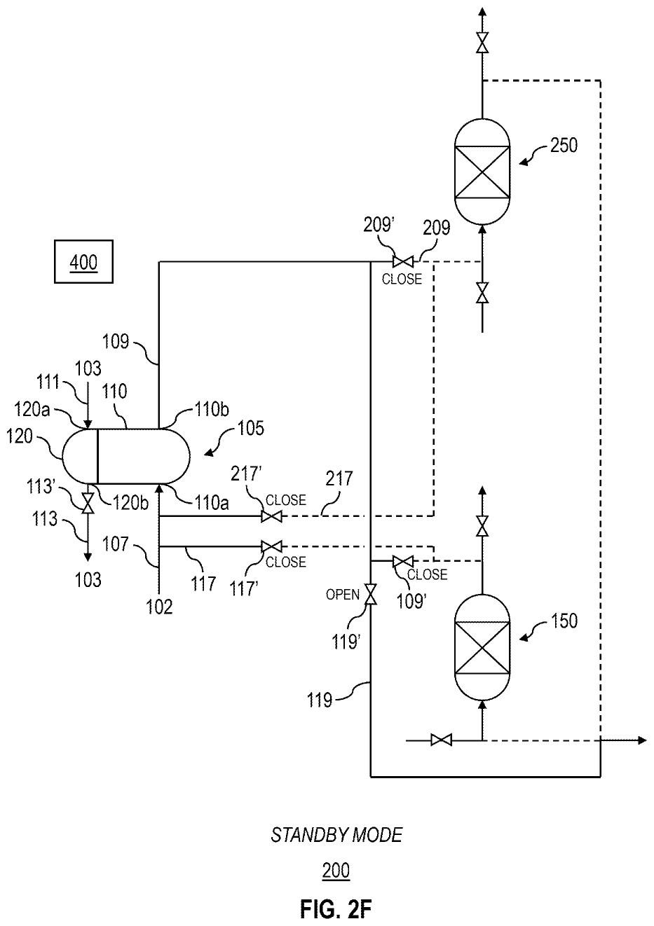

FIG. 2A is a schematic diagram of an example system 200 including an implementation of the non-cyclic heat exchanger 105 which is operated cyclically. The system 200 is substantially similar to the system 100. In comparison, the system 200 includes all of the components previously described in system 100 along with additional components. The system 200 includes a second outlet flowline 209 and a second heating control valve 209′ disposed on the second outlet flowline 209. The second outlet flowline 209 branches from the first outlet flowline 109 and is connected to a second dehydrator bed 250. The second heating control valve 209′ is configured to adjust a flow rate of at least a portion of the process fluid 102 through the second outlet flowline 209 to the second dehydrator bed 250. For example, a % opening of the second heating control valve 209′ is adjustable, and adjusting the % opening of the second heating control valve 209′ adjusts the flow rate of the portion of the process fluid 102 flowing through the second outlet flowline 209. Decreasing the % opening of the second heating control valve 209′ decreases the flow rate of the portion of the process fluid 102 flowing through the second outlet flowline 209, and increasing the % opening of the second heating control valve 209′ increases the flow rate of the portion of the process fluid 102 flowing through the second outlet flowline 209.

In some implementations, the first dehydrator bed 150 and the second dehydrator bed 250 include a substantially similar desiccant that is configured to remove water from a fluid in a gaseous state. In some implementations, the first dehydrator bed 150 and the second dehydrator bed 250 include a substantially similar desiccant that is configured to remove water from a fluid in a liquid state. An example of desiccant that can be used to remove water from liquids include molecular sieve desiccants of varying sizes for efficient moisture removal. For example, the dehydrator beds 150, 250 include molecular sieve desiccants having a pore size ranging from about 3 angstroms to about 5 angstroms or from about 3 angstroms to about 4 angstroms. As another example, the dehydrator beds 150, 250 include molecular sieve desiccants having sizes ranging from 3 A to 5 A, such as 3 A, 4 A, or 5 A. In some implementations, the first dehydrator bed 150 includes a first desiccant that is different from a second desiccant included in the second dehydrator bed 250. For example, the first desiccant of the first dehydrator bed 150 is configured to remove water from a first fluid in a gaseous state, while the second desiccant of the second dehydrator bed 250 is configured to remove water from a second fluid in a liquid state. As another example, the first desiccant of the first dehydrator bed 150 is configured to remove water from a first fluid in a liquid state, while the second desiccant of the second dehydrator bed 250 is configured to remove water from a second fluid in a gaseous state.

The system 200 includes a second cooling flowline 217 and a second cooling control valve 217′ disposed on the second cooling flowline 217. The second cooling flowline 217 branches from the inlet flowline 107 and is connected to the second dehydrator bed 250. The second cooling control valve 217′ is configured to adjust a flow rate of at least a portion of the process fluid 102 through the second cooling flowline 217 to the second dehydrator bed 250. For example, a % opening of the second cooling control valve 217′ is adjustable, and adjusting the % opening of the second cooling control valve 217′ adjusts the flow rate of the portion of the process fluid 102 flowing through the second cooling flowline 217. Decreasing the % opening of the second cooling control valve 217′ decreases the flow rate of the portion of the process fluid 102 flowing through the second cooling flowline 217, and increasing the % opening of the second cooling control valve 217′ increases the flow rate of the portion of the process fluid 102 flowing through the second cooling flowline 117.

The second heating control valve 209′ and the second cooling control valve 217′ are communicatively coupled to the controller 400. Although not shown in FIG. 2A, the controller 400 can also be communicatively coupled to additional components, such as additional control valves and/or sensors (such as temperature sensor(s), pressure sensor(s), and flow sensor(s)). The controller 400 is configured to communicate with (for example, send signal(s) to and/or receive signal(s) from) the second heating control valve 209′ and the second cooling control valve 217′ to control the respective % openings of the valves. The controller 400 can adjust the % openings of the second heating control valve 209′ and the second cooling control valve 217′ to align with the operating mode (for example, heating, cooling, standby) of the heat exchanger 105.

A second heating mode can begin once the second dehydrator bed 250 requires regeneration to remove the accumulated water. In the second heating mode, the process fluid 102 flows through the first side 110 of the heat exchanger 105. While the process fluid 102 flows through the first side 110, the heating fluid 103 flows through the second side 120 of the heat exchanger. Heat is transferred via the heat exchanger 105 from the heating fluid 103 flowing through the second side 120 to the process fluid 102 flowing through the first side 110. In the second heating mode, at least a portion of the heated process fluid 102 flows from the first side 110 of the heat exchanger 105 through the second dehydrator bed 250. Flowing the portion of the heated process fluid 102 through the second dehydrator bed 250 heats the second dehydrator bed 250. The process fluid 102 exiting the second dehydrator bed 250 can be further processed, for example, to filter the process fluid 102, to cool the process fluid 102, to compress the process fluid 102, or any combinations of these. The portion of the heated process fluid 102 is continued to flow through the second dehydrator bed 250 until the second dehydrator bed 250 reaches a second target regeneration temperature. In some implementations, the second target regeneration temperature is in a range of from about 280° C. to about 295° C. or from about 282° C. to about 292° C. In some implementations, the second target regeneration temperature of the second dehydrator bed 250 is substantially the same as the first target regeneration temperature of the first dehydrator bed 150. In the second heating mode, the controller 400 communicates with the second heating control valve 209′ to ensure the second heating control valve 209′ remains open. In the second heating mode, the controller 400 communicates with the second cooling control valve 217′ to ensure the second cooling control valve 217′ remains closed. In the second heating mode, the controller 400 communicates with the bypass control valve 119′ to ensure the bypass control valve 119′ remains closed. In the second heating mode, with the second heating control valve 209′ open, the second cooling control valve 217′ closed, and the bypass control valve 119′ closed, at least a portion of the process fluid 102 heated by the heat exchanger 105 flows through the second dehydrator bed 250 to heat the second dehydrator bed 250.

Once the second dehydrator bed 250 has reached the second target regeneration temperature, and the second dehydrator bed 250 has been regenerated, the heat exchanger 105 can be switched in operation to a second cooling mode. In the second cooling mode, a third portion 102c of the process fluid 102 is diverted away from entering the first side 110 of the heat exchanger 105 and is instead flowed through the second dehydrator bed 250. Because the third portion 102c has not flowed through the first side 110 of the heat exchanger 105, the third portion 102c remains cool (similar to the first portion 102a). Flowing the third portion 102c through the second dehydrator bed 250 cools the second dehydrator bed 250. In some implementations, a flow rate of the heating fluid 103 flowing through the second side 120 of the heat exchanger 105 is decreased in the second cooling mode to decrease the rate of heat transfer from the heating fluid 103 to the second portion 102b of the process fluid 102 flowing through the first side 110 of the heat exchanger 105. Decreasing the flow rate of the heating fluid 103 can allow for the second portion 102b of the process fluid 102 exiting the first side 110 to remain at substantially the same temperature as the process fluid 102 exiting the first side 110 in the first heating mode, so that the operating conditions of the heat exchanger 105 do not fluctuate drastically. The second portion 102b flows from the first side 110 and through the bypass flowline 119 around the second dehydrator bed 250 to avoid the second dehydrator bed 250 and rejoins the third portion 102c exiting the second dehydrator bed 250. The rejoined process stream 102 (downstream of the second dehydrator bed 250) can be further processed, for example, to filter the process fluid 102, to cool the process fluid 102, to compress the process fluid 102, or any combinations of these. The third portion 102c of the process fluid 102 is continued to flow through the second dehydrator bed 250 until the second dehydrator bed 250 reaches a second target dehydration temperature. In some implementations, the second target dehydration temperature is in a range of from about 25° C. to about 35° C. or from about 28° C. to about 31° C. In some implementations, the second target dehydration temperature of the second dehydrator bed 250 is substantially the same as the first target dehydration temperature of the first dehydrator bed 150. In the second cooling mode, the controller 400 communicates with the second heating control valve 209′ to ensure the second heating control valve 209′ remains closed. In the second cooling mode, the controller 400 communicates with the second cooling control valve 217′ to ensure the second cooling control valve 217′ remains open. In the second cooling mode, the controller 400 communicates with the bypass control valve 119′ to ensure the bypass control valve 119′ remains at least partially open. In the second cooling mode, with the second heating control valve 209′ closed, the second cooling control valve 217′ open, and the bypass control valve 119′ at least partially open, the third portion 102c of the process fluid 102 (that is not heated by the heat exchanger 105) flows through the second dehydrator bed 250 to cool the second dehydrator bed 250, while another portion of the process fluid 102 (heated by the heat exchanger 105) bypasses the second dehydrator 250.

Multiple operating modes of the heat exchanger 105 can be combined. For example, the first heating mode can be combined with the second heating mode or the second cooling mode—that is, the first heating mode and the second heating mode can occur simultaneously, or the first heating mode and the second cooling mode can occur simultaneously. As another example, the first cooling mode can be combined with the second cooling mode or the second heating mode—that is, the first cooling mode and the second cooling mode can occur simultaneously, or the first cooling mode and the second heating mode can occur simultaneously. When the heat exchanger 105 is in the first heating mode and the second heating mode simultaneously, both the first dehydrator bed 150 and the second dehydrator bed 250 are heated to regenerate both beds 150, 250. When the heat exchanger 105 is in the first heating mode and the second cooling mode simultaneously, the first dehydrator bed 150 is heated, while the second dehydrator bed 250 is cooled. When the heat exchanger 105 is in the first cooling mode and the second cooling mode simultaneously, both the first dehydrator bed 150 and the second dehydrator bed 250 are cooled. When the heat exchanger 105 is in the first cooling mode and the second heating mode simultaneously, the first dehydrator bed 150 is cooled, while the second dehydrator bed 250 is heated to regenerate the second dehydrator bed 250. When the heat exchanger 105 is in the standby mode, the dehydrator beds 150, 250 are not being heated or cooled, but instead are operating to dehydrate fluids. In the standby mode, the process fluid 102 that is heated by the heat exchanger 105 bypasses both dehydrator beds 150, 250.

FIG. 2B depicts the system 200 when the heat exchanger 105 is in the first heating mode and the second heating mode simultaneously. When the heat exchanger 105 is in the first and second heating modes simultaneously, the first dehydrator bed 150 and the second dehydrator bed 250 are being regenerated to remove accumulated water. While in the first and second heating modes, the process fluid 102 flows through the first side 110 of the heat exchanger 105. While the process fluid 102 flows through the first side 110, the heating fluid 103 flows through the second side 120 of the heat exchanger. Heat is transferred via the heat exchanger 105 from the heating fluid 103 flowing through the second side 120 to the process fluid 102 flowing through the first side 110. A first portion 202a of the heated process fluid 102 flows from the first side 110 of the heat exchanger 105 through the first dehydrator bed 150. Flowing the first portion 202a of the heated process fluid 102 through the first dehydrator bed 150 heats the first dehydrator bed 150. A second portion 202b of the heated process fluid 102 flows from the first side 110 of the heat exchanger 105 through the second dehydrator bed 250. Flowing the second portion 202b of the heated process fluid 102 through the second dehydrator bed 250 heats the second dehydrator bed 250. The process fluid 102 exiting the dehydrator beds 150, 250 can be further processed, for example, to filter the process fluid 102, to cool the process fluid 102, to compress the process fluid 102, or any combinations of these. The first portion 202a of the heated process fluid 102 is continued to flow through the first dehydrator bed 150 until the first dehydrator bed 150 reaches the first target regeneration temperature. The second portion 202b of the heated process fluid 102 is continued to flow through the second dehydrator bed 250 until the second dehydrator bed 250 reaches the second target regeneration temperature. In the first and second heating modes, the controller 400 communicates with the first heating control valve 109′ to ensure the heating control valve 109′ remains open. In the first and second heating modes, the controller 400 communicates with the second heating control valve 209′ to ensure the second heating control valve 209′ remains open. In the first and second heating modes, the controller 400 communicates with the first cooling control valve 117′ to ensure the cooling control valve 117′ remains closed. In the first and second heating modes, the controller 400 communicates with the second cooling control valve 217′ to ensure the second cooling control valve 217′ remains closed. In the first and second heating modes, the controller 400 communicates with the bypass control valve 119′ to ensure the bypass control valve 119′ remains closed. In the first and second heating modes, with the first heating control valve 109′ open, the second heating control valve 209′ open, the first cooling control valve 117′ closed, the second cooling control valve 217′ closed, and the bypass control valve 119′ closed, the process fluid 102 heated by the heat exchanger 105 splits and flows through the first dehydrator bed 150 to heat the dehydrator bed 150 and through the second dehydrator bed 250 to heat the second dehydrator bed 250.

In some implementations, the system 100 includes a first temperature sensor (not shown) coupled to the first dehydrator bed 150. The first temperature sensor can measure an operating temperature of the first dehydrator bed 150. The first temperature sensor can be communicatively coupled to the controller 400 and transmit a first temperature signal to the controller 400 representing the measured operating temperature of the first dehydrator bed 150. The controller 400 can be configured to compare the measured operating temperature of the first dehydrator bed 150 received from the first temperature sensor with the first target regeneration temperature. Once the controller 400 has determined that the first dehydrator bed 150 has reached the first target regeneration temperature, the controller 400 can be configured to automatically switch the system 100 and the heat exchanger 105 from the first heating mode to the first cooling mode. In some implementations, the system 100 includes a second temperature sensor (not shown) coupled to the second dehydrator bed 250. The second temperature sensor can measure an operating temperature of the second dehydrator bed 250. The second temperature sensor can be communicatively coupled to the controller 400 and transmit a second temperature signal to the controller 400 representing the measured operating temperature of the second dehydrator bed 250. The controller 400 can be configured to compare the measured operating temperature of the second dehydrator bed 250 received from the second temperature sensor with the second target regeneration temperature. Once the controller 400 has determined that the second dehydrator bed 250 has reached the second target regeneration temperature, the controller 400 can be configured to automatically switch the system 100 and the heat exchanger 105 from the second heating mode to the second cooling mode.

FIG. 2C is the system 200 when the heat exchanger 105 is in the first cooling mode and the second cooling mode simultaneously. In the first and second cooling modes, a first portion 202a of the process fluid 102 is diverted away from entering the first side 110 of the heat exchanger 105 and is instead flowed through the first dehydrator bed 150. Because the first portion 202a has not flowed through the first side 110 of the heat exchanger 105, the first portion 202a remains cool. Flowing the first portion 202a through the first dehydrator bed 150 cools the first dehydrator bed 150. In the first and second cooling modes, a second portion 202b of the process fluid 102 is diverted away from entering the first side 110 of the heat exchanger 105 and is instead flowed through the second dehydrator bed 250. Because the second portion 202b has not flowed through the first side 110 of the heat exchanger 105, the second portion 202b remains cool. Flowing the second portion 202b through the second dehydrator bed 250 cools the second dehydrator bed 250. The process fluid 102 exiting the dehydrator beds 150, 250 can be further processed, for example, to filter the process fluid 102, to cool the process fluid 102, to compress the process fluid 102, or any combinations of these. The first portion 202a of the process fluid 102 is continued to flow through the first dehydrator bed 150 until the first dehydrator bed 150 reaches the first target dehydration temperature. The second portion 202b of the process fluid 102 is continued to flow through the second dehydrator bed 250 until the second dehydrator bed 250 reaches the second target dehydration temperature. In the first and second cooling modes, the controller 400 communicates with the first heating control valve 109′ to ensure the first heating control valve 109′ remains closed. In the first and second cooling modes, the controller 400 communicates with the second heating control valve 209′ to ensure the second heating control valve 209′ remains closed. In the first and second cooling modes, the controller 400 communicates with the first cooling control valve 117′ to ensure the first cooling control valve 117′ remains open. In the first and second cooling modes, the controller 400 communicates with the second cooling control valve 217′ to ensure the second cooling control valve 217′ remains open. In the first and second cooling modes, the controller 400 communicates with the bypass control valve 119′ to ensure the bypass control valve 119′ remains open. In the first and second cooling modes, with the first heating control valve 109′ closed, the second heating control valve 209′ closed, the first cooling control valve 117′ open, the second cooling control valve 217′ open, and the bypass control valve 119′ open, the process fluid 102 (that is not heated by the heat exchanger 105) splits and flows through the first dehydrator bed 150 to cool the first dehydrator bed 150 and through the second dehydrator bed 250 to cool the second dehydrator bed 250. The controller 400 can be configured to compare the measured operating temperature of the first dehydrator bed 150 received from the first temperature sensor with the first target dehydration temperature. The controller 400 can be configured to compare the measured operating temperature of the second dehydrator bed 250 received from the second temperature sensor with the second target dehydration temperature. Once the controller 400 has determined that the first dehydrator bed 150 has reached the first target dehydration temperature and the second dehydrator bed 250 has reached the second target dehydration temperature, the controller 400 can be configured to automatically switch the system 100 and the heat exchanger 105 from the first and second cooling modes to the standby mode (an example is shown in FIG. 2F).

FIG. 2D is the system 200 when the heat exchanger 105 is in the first heating mode and the second cooling mode simultaneously. When the heat exchanger 105 is in the first heating mode and the second cooling mode simultaneously, the first dehydrator bed 150 is being regenerated to remove accumulated water while the second dehydrator bed 250 is being cooled. While in the first heating mode and the second cooling mode, a first portion 202a of the process fluid 102 flows through the first side 110 of the heat exchanger 105. While the first portion 202a of the process fluid 102 flows through the first side 110, the heating fluid 103 flows through the second side 120 of the heat exchanger. Heat is transferred via the heat exchanger 105 from the heating fluid 103 flowing through the second side 120 to the first portion 202a of the process fluid 102 flowing through the first side 110. The first portion 202a of the heated process fluid 102 flows from the first side 110 of the heat exchanger 105 through the first dehydrator bed 150. Flowing the first portion 202a of the heated process fluid 102 through the first dehydrator bed 150 heats the first dehydrator bed 150. A second portion 202b of the process fluid 102 is diverted away from entering the first side 110 of the heat exchanger 105 and is instead flowed through the second dehydrator bed 250. Because the second portion 202b has not flowed through the first side 110 of the heat exchanger 105, the second portion 202b remains cool. Flowing the second portion 202b through the second dehydrator bed 250 cools the second dehydrator bed 250. The process fluid 102 exiting the dehydrator beds 150, 250 can be combined and further processed, for example, to filter the process fluid 102, to cool the process fluid 102, to compress the process fluid 102, or any combinations of these. The first portion 202a of the heated process fluid 102 is continued to flow through the first dehydrator bed 150 until the first dehydrator bed 150 reaches the first target regeneration temperature. The second portion 202b of the process fluid 102 is continued to flow through the second dehydrator bed 250 until the second dehydrator bed 250 reaches the second target dehydration temperature. In the first heating mode and the second cooling mode, the controller 400 communicates with the first heating control valve 109′ to ensure the heating control valve 109′ remains open. In the first heating mode and the second cooling mode, the controller 400 communicates with the second heating control valve 209′ to ensure the second heating control valve 209′ remains closed. In the first heating mode and the second cooling mode, the controller 400 communicates with the first cooling control valve 117′ to ensure the cooling control valve 117′ remains closed. In the first heating mode and the second cooling mode, the controller 400 communicates with the second cooling control valve 217′ to ensure the second cooling control valve 217′ remains open. In the first heating mode and the second cooling mode, the controller 400 communicates with the bypass control valve 119′ to ensure the bypass control valve 119′ remains closed. In the first heating mode and the second cooling mode, with the first heating control valve 109′ open, the second heating control valve 209′ closed, the first cooling control valve 117′ closed, the second cooling control valve 217′ open, and the bypass control valve 119′ closed, a first portion 202a of the process fluid 102 is heated by the heat exchanger 105 and is flowed through the first dehydrator bed 150 to heat the dehydrator bed 150, and a second portion 202b of the process fluid 102 is not heated by the heat exchanger 105 and is flowed through the second dehydrator bed 250 to cool the second dehydrator bed 250.

The controller 400 can be configured to compare the measured operating temperature of the first dehydrator bed 150 received from the first temperature sensor with the first target regeneration temperature. Once the controller 400 has determined that the first dehydrator bed 150 has reached the first target regeneration temperature, the controller 400 can be configured to automatically switch the system 100 and the heat exchanger 105 from the first heating mode to the first cooling mode. The controller 400 can be configured to compare the measured operating temperature of the second dehydrator bed 250 received from the second temperature sensor with the second target dehydration temperature.

FIG. 2E is the system 200 when the heat exchanger 105 is in the second heating mode and the first cooling mode simultaneously. When the heat exchanger 105 is in the second heating mode and the first cooling mode simultaneously, the second dehydrator bed 250 is being regenerated to remove accumulated water while the first dehydrator bed 150 is being cooled. While in the second heating mode and the first cooling mode, a first portion 202a of the process fluid 102 flows through the first side 110 of the heat exchanger 105. While the first portion 202a of the process fluid 102 flows through the first side 110, the heating fluid 103 flows through the second side 120 of the heat exchanger. Heat is transferred via the heat exchanger 105 from the heating fluid 103 flowing through the second side 120 to the first portion 202a of the process fluid 102 flowing through the first side 110. The first portion 202a of the heated process fluid 102 flows from the first side 110 of the heat exchanger 105 through the second dehydrator bed 250. Flowing the first portion 202a of the heated process fluid 102 through the second dehydrator bed 250 heats the second dehydrator bed 250. A second portion 202b of the process fluid 102 is diverted away from entering the first side 110 of the heat exchanger 105 and is instead flowed through the first dehydrator bed 150. Because the second portion 202b has not flowed through the first side 110 of the heat exchanger 105, the second portion 202b remains cool. Flowing the second portion 202b through the first dehydrator bed 150 cools the first dehydrator bed 150. The process fluid 102 exiting the dehydrator beds 150, 250 can be combined and further processed, for example, to filter the process fluid 102, to cool the process fluid 102, to compress the process fluid 102, or any combinations of these. The first portion 202a of the heated process fluid 102 is continued to flow through the second dehydrator bed 250 until the second dehydrator bed 250 reaches the second target regeneration temperature. The second portion 202b of the process fluid 102 is continued to flow through the first dehydrator bed 150 until the first dehydrator bed 150 reaches the first target dehydration temperature. In the second heating mode and the first cooling mode, the controller 400 communicates with the first heating control valve 109′ to ensure the heating control valve 109′ remains closed. In the second heating mode and the first cooling mode, the controller 400 communicates with the second heating control valve 209′ to ensure the second heating control valve 209′ remains open. In the second heating mode and the first cooling mode, the controller 400 communicates with the first cooling control valve 117′ to ensure the cooling control valve 117′ remains open. In the second heating mode and the first cooling mode, the controller 400 communicates with the second cooling control valve 217′ to ensure the second cooling control valve 217′ remains closed. In the second heating mode and the first cooling mode, the controller 400 communicates with the bypass control valve 119′ to ensure the bypass control valve 119′ remains closed. In the second heating mode and the first cooling mode, with the first heating control valve 109′ closed, the second heating control valve 209′ open, the first cooling control valve 117′ open, the second cooling control valve 217′ closed, and the bypass control valve 119′ closed, a first portion 202a of the process fluid 102 is heated by the heat exchanger 105 and is flowed through the second dehydrator bed 250 to heat the second dehydrator bed 250, and a second portion 202b of the process fluid 102 is not heated by the heat exchanger 105 and is flowed through the first dehydrator bed 150 to cool the first dehydrator bed 150.

The controller 400 can be configured to compare the measured operating temperature of the second dehydrator bed 250 received from the second temperature sensor with the second target regeneration temperature. Once the controller 400 has determined that the second dehydrator bed 250 has reached the second target regeneration temperature, the controller 400 can be configured to automatically switch the system 100 and the heat exchanger 105 from the second heating mode to the second cooling mode. The controller 400 can be configured to compare the measured operating temperature of the first dehydrator bed 150 received from the first temperature sensor with the first target dehydration temperature.

FIG. 2F is the system 200 when the heat exchanger 105 is in the standby mode. In the standby mode, the process fluid 102 flows through the first side 110 of the heat exchanger 105. While the process fluid 102 flows through the first side 110, the heating fluid 103 flows through the second side 120 of the heat exchanger. Heat is transferred via the heat exchanger 105 from the heating fluid 103 flowing through the second side 120 to the process fluid 102 flowing through the first side 110. The process fluid 102 flows from the first side 110 and through the bypass flowline 119 around the dehydrator beds 150, 250 to avoid the dehydrator beds 150, 250. The process stream 102 (downstream of the dehydrator beds 150, 250) can be further processed, for example, to filter the process fluid 102, to cool the process fluid 102, to compress the process fluid 102, or any combinations of these. In the standby mode, the dehydrator beds 150, 250 operate to dehydrate fluids (for example, the process fluid 102 prior to entering the heat exchanger 105 and a condensate stream). In the standby mode, the controller 400 communicates with the first heating control valve 109′ to ensure the first heating control valve 109′ remains closed. In the standby mode, the controller 400 communicates with the second heating control valve 209′ to ensure the second heating control valve 209′ remains closed. In the standby mode, the controller 400 communicates with the first cooling control valve 117′ to ensure the first cooling control valve 117′ remains closed. In the standby mode, the controller 400 communicates with the second cooling control valve 217′ to ensure the second cooling control valve 217′ remains closed. In the standby mode, the controller 400 communicates with the bypass control valve 119′ to ensure the bypass control valve 119′ remains at least partially open. In the standby mode, with the first heating control valve 109′ closed, the second heating control valve 209′ closed, the first cooling control valve 117′ closed, the second cooling control valve 217′ closed, and the bypass control valve 119′ at least partially open, the process fluid 102 bypasses the dehydrators 150, 250. Because the bypass control valve 119′ is partially open, the flow rate of the process fluid 102 may be decreased in comparison to the flow rate of the process fluid 102 while the heat exchanger 105 is in the first and/or second heating modes. In some implementations, a flow rate of the heating fluid 103 flowing through the second side 120 of the heat exchanger 105 is decreased in the standby mode (for example, the same flow rate of the heating fluid 103 while the heat exchanger 105 is in the first or second cooling mode) to decrease the rate of heat transfer from the heating fluid 103 to the process fluid 102 flowing through the first side 110 of the heat exchanger 105. Decreasing the flow rate of the heating fluid 103 can allow for the process fluid 102 exiting the first side 110 in the standby mode to remain at substantially the same temperature as the process fluid 102 exiting the first side 110 in the first or second heating mode, so that the operating conditions of the heat exchanger 105 do not fluctuate drastically. Once the dehydrator beds 150, 250 reach points at which the dehydrator beds 150, 250 require regeneration to remove the accumulated water, the heat exchanger 105 (and system 100) can be switched back to the first and/or second heating modes. In this way, the non-cyclic heat exchanger 105 can be operated cyclically through the first and/or second heating modes, the first and/or second cooling modes, and the standby mode. Adjustment of flow rate of the heating fluid 103 through the second side 120 of the heat exchanger 105 allows for the heat exchanger 105 to be continually operated throughout each of the modes with its operating conditions remaining substantially stable, free of drastic fluctuations.

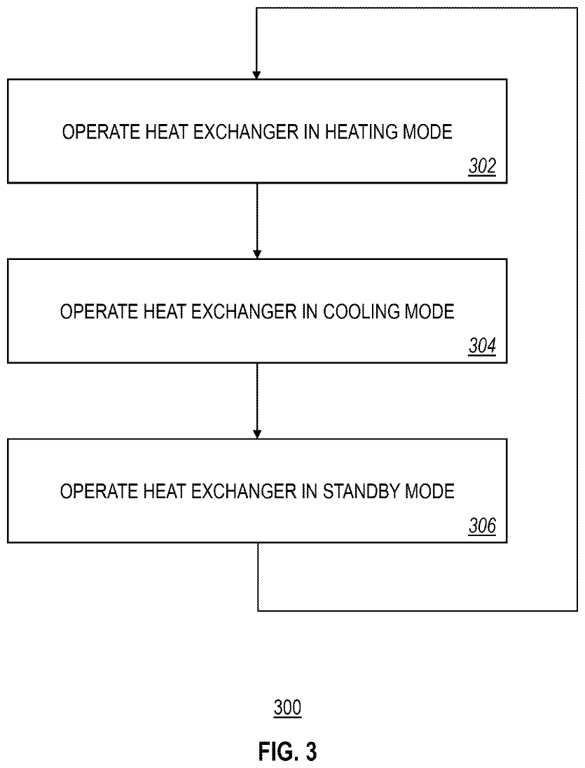

FIG. 3 is a flow chart of an example method 300 for cyclically operating a non-cyclic heat exchanger, such as the heat exchanger 105. Any one of the systems 100 or 200 can, for example, implement the method 300. At block 302, the heat exchanger 105 is operated in a heating mode (such as the first heating mode or the second heating mode). Operating the heat exchanger 105 in the first heating mode at block 302 includes flowing at least a portion of the process fluid 102 that has been heated by the heat exchanger 105 through a dehydrator bed (such as the first dehydrator bed 150) to heat the dehydrator bed 150 to the target regeneration temperature at which the dehydrator bed 150 regenerates. After the dehydrator bed 150 reaches the target regeneration temperature at block 302, the heat exchanger 105 is operated in a cooling mode (such as the first cooling mode or the second cooling mode) at block 304. Operating the heat exchanger 105 in the first cooling mode at block 304 includes flowing at least a portion of the process fluid 102 that has not been heated by the heat exchanger 105 through the dehydrator bed 150 to cool the dehydrator bed 150 to the target dehydration temperature, which is less than the target regeneration temperature (block 302). After the dehydrator bed 150 reaches the target dehydration temperature at block 304, the heat exchanger 105 is operated in a standby mode at block 306. Operating the heat exchanger 105 in the standby mode at block 306 includes flowing at least a portion of the process fluid 102 around the dehydrator bed 150 to bypass (avoid) the dehydrator bed 150. By flowing the process fluid 102 around the dehydrator bed 150 at block 306, the dehydrator bed 150 remains undisturbed to continue its dehydrating process, and the heat exchanger 105 continues to operate without requiring drastic fluctuations in its operating conditions. After block 306, the method 300 cycles back to block 302, to repeat blocks 302, 304, and 306 sequentially and cyclically, thereby operating the heat exchanger 105 in cyclic operation.

FIG. 4 is a schematic diagram of an example computer 400 that can be used to implement the method 200 and/or to cyclically operate the non-cyclic heat exchanger 105. The computer 400 can be used to provide computational functionalities associated with described algorithms, methods, functions, processes, flows, and procedures, as described in this specification, according to an implementation. The illustrated computer 400 is intended to encompass any computing device such as a server, desktop computer, laptop/notebook computer, one or more processors within these devices, or any other processing device, including physical or virtual instances (or both) of the computing device. Additionally, the computer 400 can include a computer that includes an input device, such as a keypad, keyboard, touch screen, or other device that can accept user information, and an output device that conveys information associated with the operation of the computer 400, including digital data, visual, audio information, or a combination of information.

The computer 400 includes a processor 405. The processor 405 may be a microprocessor, a multi-core processor, a multithreaded processor, an ultra-low-voltage processor, an embedded processor, or a virtual processor. In some embodiments, the processor 405 may be part of a system-on-a-chip (SoC) in which the processor 405 and the other components of the computer 400 are formed into a single integrated electronics package. In some implementations, the processor 405 may include processors from Intel® Corporation of Santa Clara, California, from Advanced Micro Devices, Inc. (AMD) of Sunnyvale, California, or from ARM Holdings, LTD., Of Cambridge, England. Any number of other processors from other suppliers may also be used. Although illustrated as a single processor 405 in FIG. 4, two or more processors may be used according to particular needs, desires, or particular implementations of the computer 400. Generally, the processor 405 executes instructions and manipulates data to perform the operations of the computer 400 and any algorithms, methods, functions, processes, flows, and procedures as described in this specification. The processor 405 may communicate with other components of the computer 400 over a bus. The bus may include any number of technologies, such as industry standard architecture (ISA), extended ISA (EISA), peripheral component interconnect (PCI), peripheral component interconnect extended (PCIx), PCI express (PCIe), or any number of other technologies. The bus may be a proprietary bus, for example, used in an SoC based system. Other bus technologies may be used, in addition to, or instead of, the technologies above.

The computer 400 also includes a memory 407 that can hold data for the computer 400 or other components (or a combination of both) that can be connected to the network. Although illustrated as a single memory 407 in FIG. 4, two or more memories 407 (of the same or combination of types) can be used according to particular needs, desires, or particular implementations of the computer 400 and the described functionality. While memory 407 is illustrated as an integral component of the computer 400, memory 407 can be external to the computer 400. The memory 407 can be a transitory or non-transitory storage medium. In some implementations, such as in PLCs and other process control units, the memory 407 is integrated with the database used for long-term storage of programs and data. The memory 407 can include any number of volatile and nonvolatile memory devices, such as volatile random-access memory (RAM), static random-access memory (SRAM), flash memory, and the like. In smaller devices, such as PLCs, the memory 407 may include registers associated with the processor 405 itself. The memory 407 stores computer-readable instructions executable by the processor 405 that, when executed, cause the processor 405 to perform operations, such as transmitting an open/close signal to the heating control valve 109′, transmitting an open/close signal to the cooling control valve 117′, or transmitting an open/close signal to the bypass control valve 119′.

Computational fluid dynamics (CFD) analysis models of an example non-cyclic heat exchanger that has been operated cyclically with drastic fluctuations in temperature were developed. The models revealed total deformation on the overall example heat exchanger, bolt load (direct stress) on the example non-cyclic heat exchanger, and loss of gasket pressure of the example non-cyclic heat exchanger. The models revealed that the gasket had encountered a loss of contact at the inner diameter. In the CFD analysis models, the heat exchanger was simulated as operating cyclically with the outlet process fluid fluctuating across a 250 degree Fahrenheit (° F.) differential. Excessive loads have acted upon bolts, joints, and gaskets within the heat exchanger, which can detrimentally lead to gasket failure and consequent uncontrolled release of process fluid from the heat exchanger. By implementing the systems 100, 200 and method 300, such unfavorable events can be avoided because the cyclic operation of the systems 100, 200 and method 300 avoid drastic fluctuations in operating conditions for the non-cyclic heat exchanger 105.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

### EMBODIMENTS

In an example implementation (or aspect), a method, for cyclically operating a non-cyclic heat exchanger, comprises: i) operating the non-cyclic heat exchanger in a heating mode comprising flowing a gas stream heated by the non-cyclic heat exchanger through a dehydrator bed to heat the dehydrator bed to a target regeneration temperature at which the dehydrator bed regenerates; ii) after the dehydrator bed reaches the target regeneration temperature, operating the non-cyclic heat exchanger in a cooling mode comprising diverting a first portion of the gas stream away from entering the first side of the non-cyclic heat exchanger and flowing the first portion of the gas stream through the dehydrator bed to cool the dehydrator bed to a target dehydrator temperature that is less than the target regeneration temperature; iii) after the dehydrator bed reaches the target dehydration temperature, operating the non-cyclic heat exchanger in a standby mode comprising flowing the gas stream from the non-cyclic heat exchanger around the dehydrator bed to bypass the dehydrator bed; and iv) repeating steps i), ii), and iii) sequentially to cyclically operate the non-cyclic heat exchanger.

In an example implementation (or aspect) combinable with any other example implementation (or aspect), the heating mode is a first heating mode, and the method further comprises operating the non-cyclic heat exchanger in a second heating mode, wherein operating the non-cyclic heat exchanger in the second heating mode comprises, after heating the gas stream, flowing at least a portion of the gas stream from the first side of the non-cyclic heat exchanger through a second dehydrator bed until the second dehydrator bed reaches a second target regeneration temperature and the second dehydrator bed has been regenerated.

In an example implementation (or aspect) combinable with any other example implementation (or aspect), the cooling mode is a first cooling mode, and the method further comprises, after the second dehydrator bed reaches the second target regeneration temperature, operating the non-cyclic heat exchanger in a second cooling mode, wherein operating the non-cyclic heat exchanger in the second cooling mode comprises diverting a third portion of the gas stream away from entering the first side of the non-cyclic heat exchanger and flowing the third portion of the gas stream through the second dehydrator bed to cool the second dehydrator bed to a second target dehydration temperature.

In an example implementation (or aspect) combinable with any other example implementation (or aspect), the non-cyclic heat exchanger is operated in the first heating mode and the second heating mode simultaneously.

In an example implementation (or aspect) combinable with any other example implementation (or aspect), the non-cyclic heat exchanger is operated in the first cooling mode and the second cooling mode simultaneously.

In an example implementation (or aspect) combinable with any other example implementation (or aspect), the non-cyclic heat exchanger is operated in the first heating mode and the second cooling mode simultaneously.

In an example implementation (or aspect) combinable with any other example implementation (or aspect), the non-cyclic heat exchanger is operated in the second heating mode and the first cooling mode simultaneously.

In an example implementation (or aspect) combinable with any other example implementation (or aspect), the non-cyclic heat exchanger is operated in the standby mode after the dehydrator bed reaches the target dehydration temperature and after the second dehydrator bed reaches the second target dehydration temperature.

In an example implementation (or aspect), a system comprises: a non-cyclic heat exchanger comprising a first side configured to receive a process fluid and a second side configured to receive a heating fluid, wherein the non-cyclic heat exchanger is configured to transfer heat from the heating fluid flowing through the second side to the process fluid flowing through the first side; an inlet flowline connected to an inlet of the first side of the non-cyclic heat exchanger; an outlet flowline connected to an outlet of the first side of the non-cyclic heat exchanger; a dehydrator bed connected to the outlet flowline; a discharge flowline connected to the dehydrator bed, wherein the outlet flowline and the discharge flowline are connected at opposite ends of the dehydrator bed; a cooling flowline branching from the inlet flowline and connected to the dehydrator bed, wherein the outlet flowline and the cooling flowline are connected at the same end of the dehydrator bed; a bypass flowline branching from the outlet flowline and connected to the discharge flowline, wherein the bypass flowline is configured to provide an alternative flow path for at least a portion of the process fluid flowing through the outlet flowline to bypass and avoid the dehydrator bed and flow directly to the discharge flowline; a heating control valve disposed on the outlet flowline, wherein the heating control valve is configured to adjust a flow rate of at least a portion of the process fluid through the outlet flowline to the dehydrator bed; a cooling control valve disposed on the cooling flowline, wherein the cooling control valve is configured to adjust a flow rate of at least a portion of the process fluid through the cooling flowline to the dehydrator bed; a bypass control valve disposed on the bypass flowline, wherein the bypass flowline is configured to adjust a flow rate of at least a portion of the process fluid through the bypass flowline avoiding the dehydrator bed to the discharge flowline; and a controller communicatively coupled to the heating control valve, the cooling control valve, and the bypass control valve, wherein the controller is configured to cause the bypass control valve to at least partially open to flow at least a portion of the process fluid from the non-cyclic heat exchanger around the dehydrator bed to the discharge flowline, thereby bypassing the dehydrator bed while the non-cyclic heat exchanger operates.

In an example implementation (or aspect) combinable with any other example implementation (or aspect), the controller is configured to: after a standby mode of the non-cyclic heat exchanger and in a heating mode of the non-cyclic heat exchanger, cause the heating control valve to open, the cooling control valve to close, and the bypass control valve to close, thereby flowing at least a portion of the process fluid from the non-cyclic heat exchanger through the dehydrator bed to heat to a target regeneration temperature; after the heating mode and in a cooling mode of the non-cyclic heat exchanger, cause the heating control valve to close, the cooling control valve to open, and the bypass control valve to remain closed, thereby diverting a first portion of the process fluid around the non-cyclic heat exchanger to the dehydrator bed to cool to a target dehydration temperature; and after the cooling mode and in the standby mode, cause the heating control valve to remain closed, the cooling control valve to close, and the bypass control valve to open, thereby flowing the process fluid from the non-cyclic heat exchanger around the dehydrator bed to the discharge flowline.

In an example implementation (or aspect) combinable with any other example implementation (or aspect), the system further comprises: a second outlet flowline branching from the outlet flowline and connected to a second dehydrator bed; a second heating control valve disposed on the second outlet flowline, wherein the second heating control valve is configured to adjust a flow rate of at least a portion of the process fluid through the second outlet flowline to the second dehydrator bed; a second cooling flowline branching from the inlet flowline and connected to the second dehydrator bed; and a second cooling control valve disposed on the second cooling flowline, wherein the second cooling control valve is configured to adjust a flow rate of at least a portion of the process fluid through the second cooling flowline to the second dehydrator bed.

In an example implementation (or aspect) combinable with any other example implementation (or aspect), the controller is communicatively coupled to the second heating control valve and the second cooling control valve, the heating mode is a first cooling mode, and the controller is configured to, after the standby mode and in a second heating mode, cause the second heating control valve to open, the second cooling control valve to close, and the bypass control valve to close, thereby flowing at least a portion of the process fluid from the non-cyclic heat exchanger through the second dehydrator bed to heat to a second target regeneration temperature.

In an example implementation (or aspect) combinable with any other example implementation (or aspect), the cooling mode is a first cooling mode, and the controller is configured to, after the second heating mode and in a second cooling mode, cause the second heating control valve to close, the second cooling control valve to open, and the bypass control valve to close, thereby diverting a second portion of the process fluid around the non-cyclic heat exchanger to the second dehydrator bed to cool to a second target dehydration temperature.

In an example implementation (or aspect) combinable with any other example implementation (or aspect), the controller is configured to, in the first heating mode concurrently with the second heating mode, cause the first heating control valve and the second heating control valve to open, the first cooling control valve and the second cooling control valve to close, and the bypass control valve to close, thereby flowing a first heating portion of the process fluid from the non-cyclic heat exchanger through the dehydrator bed to heat to the target regeneration temperature and flowing a second heating portion of the process fluid from the non-cyclic heat exchanger through the second dehydrator bed to heat to the second target regeneration temperature.

In an example implementation (or aspect) combinable with any other example implementation (or aspect), the controller is configured to, in the first cooling mode concurrently with the second cooling mode, cause the first heating control valve and the second heating control valve to close, the first cooling control valve and the second cooling control valve to open, and the bypass control valve to open, thereby diverting the first portion of the process fluid around the non-cyclic heat exchanger to the dehydrator bed to cool to the target dehydration temperature, diverting the second portion of the process fluid around the non-cyclic heat exchanger to the second dehydrator bed to cool to the second target dehydration temperature, and flowing a third portion of the process fluid from the non-cyclic heat exchanger around the dehydrator bed to bypass the dehydrator bed.

In an example implementation (or aspect) combinable with any other example implementation (or aspect), the controller is configured to, in the first heating mode concurrently with the second cooling mode, cause the first heating control valve to open, the second heating control valve to close, the first cooling control valve to close, the second cooling control valve to open, and the bypass control valve to close, thereby flowing a heating portion of the process fluid from the non-cyclic heat exchanger through the dehydrator bed to heat to the target regeneration temperature and diverting a cooling portion of the process fluid around the non-cyclic heat exchanger to the second dehydrator bed to cool to a second target dehydration temperature.

In an example implementation (or aspect) combinable with any other example implementation (or aspect), the controller is configured to, in the second heating mode concurrently with the first cooling mode, cause the first heating control valve to close, the second heating control valve to open, the first cooling control valve to open, the second cooling control valve to close, and the bypass control valve to close, thereby flowing a heating portion of the process fluid from the non-cyclic heat exchanger through the second dehydrator bed to heat to the second target regeneration temperature and diverting a cooling portion of the process fluid around the non-cyclic heat exchanger to the dehydrator bed to cool to the target dehydration temperature.

In an example implementation (or aspect), a computer system comprises: one or more processors; and a non-transitory computer-readable storage medium coupled to the one or more processors and storing programming instructions for execution by the one or more processors, the programming instructions instructing the one or more processors to perform operations comprising: operating the non-cyclic heat exchanger in a first heating mode, wherein operating the non-cyclic heat exchanger in the first heating mode comprises: causing a first heating control valve disposed on a first outlet flowline connecting the non-cyclic heat exchanger to a first dehydrator bed to open; causing a first cooling control valve disposed on a first cooling flowline branching from an inlet flowline upstream of the non-cyclic heat exchanger and connecting to the first dehydrator bed to close; and causing a bypass control valve disposed on a bypass flowline branching from the first outlet flowline and connecting to a discharge flowline downstream of the first dehydrator bed to close, wherein causing the first heating control valve to open, the first cooling control valve to close, and the bypass control valve to close allows at least a portion of a process fluid to flow from the non-cyclic heat exchanger through the first dehydrator bed to heat to a first target regeneration temperature; after operating the non-cyclic heat exchanger in the first heating mode, operating the non-cyclic heat exchanger in a first cooling mode, wherein operating the non-cyclic heat exchanger in the first cooling mode comprises causing the first heating control valve to close, the first cooling control valve to open, and the bypass control valve to remain closed, thereby diverting at least a portion of the process fluid around the non-cyclic heat exchanger to the first dehydrator bed to cool to a first target dehydration temperature; after operating the non-cyclic heat exchanger in the first cooling mode, operating the non-cyclic heat exchanger in a standby mode, wherein operating the non-cyclic heat exchanger in the standby mode comprises causing the first heating control valve to remain closed the first cooling control valve to close, and the bypass control valve to open, thereby flowing at least a portion of the process fluid from the non-cyclic heat exchanger around the dehydrator bed to the discharge flowline; and after operating the non-cyclic heat exchanger in the standby mode, re-operating the non-cyclic heat exchanger in the first heating mode to regenerate the first dehydrator bed.

In an example implementation (or aspect) combinable with any other example implementation (or aspect), the operations further comprise operating the non-cyclic heat exchanger in a second heating mode, wherein operating the non-cyclic heat exchanger in the second heating mode comprises: causing a second heating control valve disposed on a second outlet flowline branching from the first outlet flowline and connecting to a second dehydrator bed to open; causing a second cooling control valve disposed on a second cooling flowline branching from the inlet flowline and connecting to the second dehydrator bed to close; and causing the bypass control valve to close, wherein causing the second heating control valve to open, the second cooling control valve to close, and the bypass control valve to close allows at least a portion of a process fluid to flow from the non-cyclic heat exchanger through the second dehydrator bed to heat to a second target regeneration temperature.

In an example implementation (or aspect) combinable with any other example implementation (or aspect), the operations further comprise operating the non-cyclic heat exchanger in a second cooling mode, wherein operating the non-cyclic heat exchanger in the second cooling mode comprises causing the second heating control valve to close, the second cooling control valve to open, and the bypass control valve to remain closed, thereby diverting a second portion of the process fluid around the non-cyclic heat exchanger to the second dehydrator bed to cool to a second target dehydration temperature.

What is claimed is:

1. A method for cyclically operating a non-cyclic heat exchanger, the method comprising:
i) operating the non-cyclic heat exchanger in a heating mode comprising flowing a gas stream heated by the non-cyclic heat exchanger through a dehydrator bed to heat the dehydrator bed to a target regeneration temperature at which the dehydrator bed regenerates;
ii) after the dehydrator bed reaches the target regeneration temperature, operating the non-cyclic heat exchanger in a cooling mode comprising diverting a first portion of the gas stream away from entering the first side of the non-cyclic heat exchanger and flowing the first portion of the gas stream through the dehydrator bed to cool the dehydrator bed to a target dehydrator temperature that is less than the target regeneration temperature;
iii) after the dehydrator bed reaches the target dehydration temperature, operating the non-cyclic heat exchanger in a standby mode comprising flowing the gas stream from the non-cyclic heat exchanger around the dehydrator bed to bypass the dehydrator bed; and
iv) repeating steps i), ii), and iii) sequentially to cyclically operate the non-cyclic heat exchanger.

2. The method of claim 1, wherein the heating mode is a first heating mode, and the method further comprises operating the non-cyclic heat exchanger in a second heating mode, wherein operating the non-cyclic heat exchanger in the second heating mode comprises, after heating the gas stream, flowing at least a portion of the gas stream from the first side of the non-cyclic heat exchanger through a second dehydrator bed until the second dehydrator bed reaches a second target regeneration temperature and the second dehydrator bed has been regenerated.

3. The method of claim 2, wherein the cooling mode is a first cooling mode, and the method further comprises, after the second dehydrator bed reaches the second target regeneration temperature, operating the non-cyclic heat exchanger in a second cooling mode, wherein operating the non-cyclic heat exchanger in the second cooling mode comprises diverting a third portion of the gas stream away from entering the first side of the non-cyclic heat exchanger and flowing the third portion of the gas stream through the second dehydrator bed to cool the second dehydrator bed to a second target dehydration temperature.

4. The method of claim 3, wherein the non-cyclic heat exchanger is operated in the first heating mode and the second heating mode simultaneously.

5. The method of claim 3, wherein the non-cyclic heat exchanger is operated in the first cooling mode and the second cooling mode simultaneously.

6. The method of claim 3, wherein the non-cyclic heat exchanger is operated in the first heating mode and the second cooling mode simultaneously.

7. The method of claim 3, wherein the non-cyclic heat exchanger is operated in the second heating mode and the first cooling mode simultaneously.

8. The method of claim 3, wherein the non-cyclic heat exchanger is operated in the standby mode after the dehydrator bed reaches the target dehydration temperature and after the second dehydrator bed reaches the second target dehydration temperature.

9. A system comprising:
a non-cyclic heat exchanger comprising a first side configured to receive a process fluid and a second side configured to receive a heating fluid, wherein the non-cyclic heat exchanger is configured to transfer heat from the heating fluid flowing through the second side to the process fluid flowing through the first side;
an inlet flowline connected to an inlet of the first side of the non-cyclic heat exchanger;
an outlet flowline connected to an outlet of the first side of the non-cyclic heat exchanger;
a dehydrator bed connected to the outlet flowline;
a discharge flowline connected to the dehydrator bed, wherein the outlet flowline and the discharge flowline are connected at opposite ends of the dehydrator bed;
a cooling flowline branching from the inlet flowline and connected to the dehydrator bed, wherein the outlet flowline and the cooling flowline are connected at the same end of the dehydrator bed;
a bypass flowline branching from the outlet flowline and connected to the discharge flowline, wherein the bypass flowline is configured to provide an alternative flow path for at least a portion of the process fluid flowing through the outlet flowline to bypass and avoid the dehydrator bed and flow directly to the discharge flowline;
a heating control valve disposed on the outlet flowline, wherein the heating control valve is configured to adjust a flow rate of at least a portion of the process fluid through the outlet flowline to the dehydrator bed;
a cooling control valve disposed on the cooling flowline, wherein the cooling control valve is configured to adjust a flow rate of at least a portion of the process fluid through the cooling flowline to the dehydrator bed;
a bypass control valve disposed on the bypass flowline, wherein the bypass flowline is configured to adjust a flow rate of at least a portion of the process fluid through the bypass flowline avoiding the dehydrator bed to the discharge flowline; and
a controller communicatively coupled to the heating control valve, the cooling control valve, and the bypass control valve, wherein the controller is configured to cause the bypass control valve to at least partially open to flow at least a portion of the process fluid from the non-cyclic heat exchanger around the dehydrator bed to the discharge flowline, thereby bypassing the dehydrator bed while the non-cyclic heat exchanger operates.

10. The system of claim 10, wherein the controller is configured to:
after a standby mode of the non-cyclic heat exchanger and in a heating mode of the non-cyclic heat exchanger, cause the heating control valve to open, the cooling control valve to close, and the bypass control valve to close, thereby flowing at least a portion of the process fluid from the non-cyclic heat exchanger through the dehydrator bed to heat to a target regeneration temperature;
after the heating mode and in a cooling mode of the non-cyclic heat exchanger, cause the heating control valve to close, the cooling control valve to open, and the bypass control valve to remain closed, thereby diverting a first portion of the process fluid around the non-cyclic heat exchanger to the dehydrator bed to cool to a target dehydration temperature; and
after the cooling mode and in the standby mode, cause the heating control valve to remain closed, the cooling control valve to close, and the bypass control valve to open, thereby flowing the process fluid from the non-cyclic heat exchanger around the dehydrator bed to the discharge flowline.

11. The system of claim 10, further comprising:
a second outlet flowline branching from the outlet flowline and connected to a second dehydrator bed;
a second heating control valve disposed on the second outlet flowline, wherein the second heating control valve is configured to adjust a flow rate of at least a portion of the process fluid through the second outlet flowline to the second dehydrator bed;
a second cooling flowline branching from the inlet flowline and connected to the second dehydrator bed; and
a second cooling control valve disposed on the second cooling flowline, wherein the second cooling control valve is configured to adjust a flow rate of at least a portion of the process fluid through the second cooling flowline to the second dehydrator bed.

12. The system of claim 11, wherein the controller is communicatively coupled to the second heating control valve and the second cooling control valve, the heating mode is a first cooling mode, and the controller is configured to, after the standby mode and in a second heating mode, cause the second heating control valve to open, the second cooling control valve to close, and the bypass control valve to close, thereby flowing at least a portion of the process fluid from the non-cyclic heat exchanger through the second dehydrator bed to heat to a second target regeneration temperature.

13. The system of claim 12, wherein the cooling mode is a first cooling mode, and the controller is configured to, after the second heating mode and in a second cooling mode, cause the second heating control valve to close, the second cooling control valve to open, and the bypass control valve to close, thereby diverting a second portion of the process fluid around the non-cyclic heat exchanger to the second dehydrator bed to cool to a second target dehydration temperature.

14. The system of claim 13, wherein the controller is configured to, in the first heating mode concurrently with the second heating mode, cause the first heating control valve and the second heating control valve to open, the first cooling control valve and the second cooling control valve to close, and the bypass control valve to close, thereby flowing a first heating portion of the process fluid from the non-cyclic heat exchanger through the dehydrator bed to heat to the target regeneration temperature and flowing a second heating portion of the process fluid from the non-cyclic heat exchanger through the second dehydrator bed to heat to the second target regeneration temperature.

15. The system of claim 13, wherein the controller is configured to, in the first cooling mode concurrently with the second cooling mode, cause the first heating control valve and the second heating control valve to close, the first cooling control valve and the second cooling control valve to open, and the bypass control valve to open, thereby diverting the first portion of the process fluid around the non-cyclic heat exchanger to the dehydrator bed to cool to the target dehydration temperature, diverting the second portion of the process fluid around the non-cyclic heat exchanger to the second dehydrator bed to cool to the second target dehydration temperature, and flowing a third portion of the process fluid from the non-cyclic heat exchanger around the dehydrator bed to bypass the dehydrator bed.

16. The system of claim 13, wherein the controller is configured to, in the first heating mode concurrently with the second cooling mode, cause the first heating control valve to open, the second heating control valve to close, the first cooling control valve to close, the second cooling control valve to open, and the bypass control valve to close, thereby flowing a heating portion of the process fluid from the non-cyclic heat exchanger through the dehydrator bed to heat to the target regeneration temperature and diverting a cooling portion of the process fluid around the non-cyclic heat exchanger to the second dehydrator bed to cool to a second target dehydration temperature.

17. The system of claim 13, wherein the controller is configured to, in the second heating mode concurrently with the first cooling mode, cause the first heating control valve to close, the second heating control valve to open, the first cooling control valve to open, the second cooling control valve to close, and the bypass control valve to close, thereby flowing a heating portion of the process fluid from the non-cyclic heat exchanger through the second dehydrator bed to heat to the second target regeneration temperature and diverting a cooling portion of the process fluid around the non-cyclic heat exchanger to the dehydrator bed to cool to the target dehydration temperature.

18. A computer system comprising:
one or more processors; and
a non-transitory computer-readable storage medium coupled to the one or more processors and storing programming instructions for execution by the one or more processors, the programming instructions instructing the one or more processors to perform operations comprising:
operating the non-cyclic heat exchanger in a first heating mode, wherein operating the non-cyclic heat exchanger in the first heating mode comprises:
causing a first heating control valve disposed on a first outlet flowline connecting the non-cyclic heat exchanger to a first dehydrator bed to open;
causing a first cooling control valve disposed on a first cooling flowline branching from an inlet flowline upstream of the non-cyclic heat exchanger and connecting to the first dehydrator bed to close; and
causing a bypass control valve disposed on a bypass flowline branching from the first outlet flowline and connecting to a discharge flowline downstream of the first dehydrator bed to close, wherein causing the first heating control valve to open, the first cooling control valve to close, and the bypass control valve to close allows at least a portion of a process fluid to flow from the non-cyclic heat exchanger through the first dehydrator bed to heat to a first target regeneration temperature;
after operating the non-cyclic heat exchanger in the first heating mode, operating the non-cyclic heat exchanger in a first cooling mode, wherein operating the non-cyclic heat exchanger in the first cooling mode comprises causing the first heating control valve to close, the first cooling control valve to open, and the bypass control valve to remain closed, thereby diverting at least a portion of the process fluid around the non-cyclic heat exchanger to the first dehydrator bed to cool to a first target dehydration temperature;
after operating the non-cyclic heat exchanger in the first cooling mode, operating the non-cyclic heat exchanger in a standby mode, wherein operating the non-cyclic heat exchanger in the standby mode comprises causing the first heating control valve to remain closed the first cooling control valve to close, and the bypass control valve to open, thereby flowing at least a portion of the process fluid from the non-cyclic heat exchanger around the dehydrator bed to the discharge flowline; and
after operating the non-cyclic heat exchanger in the standby mode, re-operating the non-cyclic heat exchanger in the first heating mode to regenerate the first dehydrator bed.

19. The computer system of claim 18, wherein the operations further comprise operating the non-cyclic heat exchanger in a second heating mode, wherein operating the non-cyclic heat exchanger in the second heating mode comprises:
causing a second heating control valve disposed on a second outlet flowline branching from the first outlet flowline and connecting to a second dehydrator bed to open;
causing a second cooling control valve disposed on a second cooling flowline branching from the inlet flowline and connecting to the second dehydrator bed to close; and
causing the bypass control valve to close, wherein causing the second heating control valve to open, the second cooling control valve to close, and the bypass control valve to close allows at least a portion of a process fluid to flow from the non-cyclic heat exchanger through the second dehydrator bed to heat to a second target regeneration temperature.

20. The computer system of claim 19, wherein the operations further comprise operating the non-cyclic heat exchanger in a second cooling mode, wherein operating the non-cyclic heat exchanger in the second cooling mode comprises causing the second heating control valve to close, the second cooling control valve to open, and the bypass control valve to remain closed, thereby diverting a second portion of the process fluid around the non-cyclic heat exchanger to the second dehydrator bed to cool to a second target dehydration temperature.
